(19) United States
(12) Patent Application Publication
(10) Pub. No.: US 2025/0142295 A1
(43) Pub. Date: May 1, 2025

(54) METHOD AND APPARATUS FOR GROUP MESSAGE DELIVERY

(71) Applicant: Telefonaktiebolaget LM Ericsson (publ), Stockholm (SE)

(72) Inventors: Jie Ling, Shanghai (CN); Juying Gan, Shanghai (CN); Shabnam Sultana, Montreal (CA); Thorsten Lohmar, Aachen (DE)

(21) Appl. No.: 18/836,194

(22) PCT Filed: Feb. 3, 2023
(86) PCT No.: PCT/CN2023/074378

§ 371 Date: Aug. 6, 2024

(30) Foreign Application Priority Data
Feb. 8, 2022 (WO) PCT/CN2022/075440

(51) Int. Cl. H04W 4/08; H04W 4/12

(52) U.S. Cl. CPC H04W 4/08; H04W 4/12

(57) ABSTRACT

Various embodiments of the present disclosure provide a method for group message delivery. The method which may be performed by a user equipment comprises: obtaining meta data information of a group message from an application server. In accordance with an exemplary embodiment, the method further comprises: receiving a file from a multicast/broadcast service entity. The file may be transformed from the group message. In accordance with an exemplary embodiment, the method further comprises: transforming the file into the group message, according to the meta data information.

### FIELD OF THE INVENTION

The present disclosure generally relates to communication networks, and more specifically, to a method and apparatus for group message delivery.

### BACKGROUND

This section introduces aspects that may facilitate a better understanding of the disclosure. Accordingly, the statements of this section are to be read in this light and are not to be understood as admissions about what is in the prior art or what is not in the prior art.

Multimedia broadcast/multicast service (MBMS) is a point-to-multipoint service in which data is transmitted from a single source entity to multiple recipients, as described in the 3rd generation partnership project (3GPP) technical specification (TS) 23.246 V16.1.0. Transmitting the same data to multiple recipients allows network resources to be shared. The MBMS bearer service may offer broadcast mode and multicast mode. Corresponding to MBMS in an evolved packet system (EPS), multicast/broadcast service (MBS) in the fifth generation system (5GS) is also a point-to-multipoint service in which data is transmitted from a single source entity to multiple recipients, either to all users in a broadcast service area, or to users in a multicast group as defined in 3GPP TS 23.247 v17.1.0. Both MBS and MBMS comply to the requirements specified in 3GPP TS 22.146 v16.0.0. The corresponding types of MBS session may include broadcast session and multicast session.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

For multicast and broadcast communications in EPS, it may be expected to deliver a group message from an application server to a group of user equipments (UEs) over MBMS. For example, the application server may send the group message to a service capability exposure function (SCEF) which may provide the group message to the UEs via a broadcast/multicast-service center (BM-SC). However, according to the existing solutions, the BM-SC may only be capable of delivering a file over MBMS but not support a group message delivery. In addition, even if the UEs can receive the group message in a file from the BM-SC, the UEs may not be able to interpret the group message from the file because the UEs may have no meta data of the file. For 5GS, the group message delivery using MBS is still an open issue. Therefore, it may be desirable to implement group message delivery over MBMS and/or MBS in a more efficient way.

Various exemplary embodiments of the present disclosure propose a solution for group message delivery, which can enable a group message to be delivered to one or more UEs in a file over MBMS and/or MBS, and provide group message meta data to the one or more UEs, so that the one or more UEs can get the group message from the file according to the group message meta data.

According to a first aspect of the present disclosure, there is provided a method performed by a UE. The method comprises: obtaining meta data information of a group message from an application server. In accordance with an exemplary embodiment, the method further comprises: receiving a file from a multicast/broadcast service entity. The file may be transformed from the group message. In accordance with an exemplary embodiment, the method further comprises: transforming the file into the group message, according to the meta data information.

In accordance with an exemplary embodiment, the UE may obtain the meta data information via service announcement by the application server.

In accordance with an exemplary embodiment, the meta data information may include a uniform resource locator (URL) of the file.

In accordance with an exemplary embodiment, the UE may receive the file from the multicast/broadcast service entity via a file delivery over MBMS and/or MBS.

In accordance with an exemplary embodiment, the multicast/broadcast service entity may be: a BM-SC, and/or a multicast/broadcast service function (MBSF) entity, and/or a multicast/broadcast service transport function (MBSTF) entity.

According to a second aspect of the present disclosure, there is provided an apparatus which may be implemented as a UE. The apparatus may comprise one or more processors and one or more memories storing computer program codes. The one or more memories and the computer program codes may be configured to, with the one or more processors, cause the apparatus at least to perform any step of the method according to the first aspect of the present disclosure.

According to a third aspect of the present disclosure, there is provided a computer-readable medium having computer program codes embodied thereon which, when executed on a computer, cause the computer to perform any step of the method according to the first aspect of the present disclosure.

According to a fourth aspect of the present disclosure, there is provided an apparatus which may be implemented as a UE. The apparatus may comprise an obtaining unit, a receiving unit and a transforming unit. In accordance with some exemplary embodiments, the obtaining unit may be operable to carry out at least the obtaining step of the method according to the first aspect of the present disclosure. The receiving unit may be operable to carry out at least the receiving step of the method according to the first aspect of the present disclosure. The transforming unit may be operable to carry out at least the transforming step of the method according to the first aspect of the present disclosure.

According to a fifth aspect of the present disclosure, there is provided a method performed by a multicast/broadcast service entity (e.g., a BM-SC and/or an MBSF entity and/or an MBSTF entity, etc.). The method comprises: obtaining a file which is transformed from a group message. In accordance with an exemplary embodiment, the method further comprises: transmitting the file to one or more UEs via a file delivery over MBMS and/or MBS.

In accordance with an exemplary embodiment, the method according to the fifth aspect of the present disclosure may further comprise: receiving meta data information of the group message from a capability exposure entity.

In accordance with an exemplary embodiment, the meta data information may be received by the multicast/broadcast service entity in an update session procedure and/or a message delivery request from the capability exposure entity.

In accordance with an exemplary embodiment, the meta data information may include a URL of the file.

In accordance with an exemplary embodiment, the multicast/broadcast service entity may obtain the file via pushing the file from a capability exposure entity to the multicast/broadcast service entity. Alternatively or additionally, the multicast/broadcast service entity may obtain the file via pulling the file from the capability exposure entity to the multicast/broadcast service entity directly or via a data server.

In accordance with an exemplary embodiment, the multicast/broadcast service entity may obtain the file by receiving a message delivery request from a capability exposure entity. The message delivery request may include the group message.

In accordance with an exemplary embodiment, the multicast/broadcast service entity may obtain the file further by transforming the group message into the file.

In accordance with an exemplary embodiment, the capability exposure entity may be a network exposure function (NEF) entity and/or an SCEF entity.

In accordance with an exemplary embodiment, prior to transmitting the file to the one or more UEs, the multicast/broadcast service entity may perform file partition and encoding for the file and start a MBMS and/or MBS session for the group message.

According to a sixth aspect of the present disclosure, there is provided an apparatus which may be implemented as a multicast/broadcast service entity. The apparatus may comprise one or more processors and one or more memories storing computer program codes. The one or more memories and the computer program codes may be configured to, with the one or more processors, cause the apparatus at least to perform any step of the method according to the fifth aspect of the present disclosure.

According to a seventh aspect of the present disclosure, there is provided a computer-readable medium having computer program codes embodied thereon which, when executed on a computer, cause the computer to perform any step of the method according to the fifth aspect of the present disclosure.

According to an eighth aspect of the present disclosure, there is provided an apparatus which may be implemented as a multicast/broadcast service entity. The apparatus may comprise an obtaining unit and a transmitting unit. In accordance with some exemplary embodiments, the obtaining unit may be operable to carry out at least the obtaining step of the method according to the fifth aspect of the present disclosure. The transmitting unit may be operable to carry out at least the transmitting step of the method according to the fifth aspect of the present disclosure.

According to a ninth aspect of the present disclosure, there is provided a method performed by a capability exposure entity (e.g., a SCEF entity and/or an NEF entity, etc.). The method comprises: determining meta data information of a group message received from an application server. In accordance with an exemplary embodiment, the method further comprises: transmitting the meta data information to the application server. In accordance with an exemplary embodiment, the method further comprises: providing the group message in a first format or a second format to a multicast/broadcast service entity (e.g., a BM-SC and/or an MBSF entity and/or an MBSTF entity, etc.). The first format is different from the second format.

In accordance with an exemplary embodiment, the method according to the ninth aspect of the present disclosure may further comprise: transmitting the meta data information to the multicast/broadcast service entity.

In accordance with an exemplary embodiment, the meta data information may be transmitted to the multicast/broadcast service entity in an update session procedure and/or a message delivery request from the capability exposure entity.

In accordance with an exemplary embodiment, the meta data information may include a URL of a file transformed from the group message.

In accordance with an exemplary embodiment, the group message in the first format may be a file transformed from the group message.

In accordance with an exemplary embodiment, the capability exposure entity may provide the group message in the first format to the multicast/broadcast service entity via pushing the file from the capability exposure entity to the multicast/broadcast service entity. Alternatively or additionally, the capability exposure entity may provide the group message in the first format to the multicast/broadcast service entity via pulling the file from the capability exposure entity to the multicast/broadcast service entity directly or via a data server.

In accordance with an exemplary embodiment, the group message in the second format may be the group message included in a message delivery request.

According to a tenth aspect of the present disclosure, there is provided an apparatus which may be implemented as a capability exposure entity. The apparatus may comprise one or more processors and one or more memories storing computer program codes. The one or more memories and the computer program codes may be configured to, with the one or more processors, cause the apparatus at least to perform any step of the method according to the ninth aspect of the present disclosure.

According to an eleventh aspect of the present disclosure, there is provided a computer-readable medium having computer program codes embodied thereon which, when executed on a computer, cause the computer to perform any step of the method according to the ninth aspect of the present disclosure.

According to a twelfth aspect of the present disclosure, there is provided an apparatus which may be implemented as a capability exposure entity. The apparatus may comprise a determining unit, a transmitting unit and a providing unit. In accordance with some exemplary embodiments, the determining unit may be operable to carry out at least the determining step of the method according to the ninth aspect of the present disclosure. The transmitting unit may be operable to carry out at least the transmitting step of the method according to the ninth aspect of the present disclosure. The providing unit may be operable to carry out at least the providing step of the method according to the ninth aspect of the present disclosure.

According to a thirteenth aspect of the present disclosure, there is provided a method performed by an application server (e.g., a service capability server (SCS) and/or an application server (AS) and/or an application function (AF), etc.). The method comprises: transmitting a group message of one or more UEs to a capability exposure entity (e.g., an SCEF entity and/or a NEF entity, etc.). In accordance with an exemplary embodiment, the method further comprises: receiving meta data information of the group message from the capability exposure entity. In accordance with an exemplary embodiment, the method further comprises: providing the meta data information to the one or more UEs.

In accordance with an exemplary embodiment, the application server may provide the meta data information to the one or more UEs via service announcement.

In accordance with an exemplary embodiment, the meta data information may include a URL of a file transformed from the group message.

According to a fourteenth aspect of the present disclosure, there is provided an apparatus which may be implemented as an application server. The apparatus may comprise one or more processors and one or more memories storing computer program codes. The one or more memories and the computer program codes may be configured to, with the one or more processors, cause the apparatus at least to perform any step of the method according to the thirteenth aspect of the present disclosure.

According to a fifteenth aspect of the present disclosure, there is provided a computer-readable medium having computer program codes embodied thereon which, when executed on a computer, cause the computer to perform any step of the method according to the thirteenth aspect of the present disclosure.

According to a sixteenth aspect of the present disclosure, there is provided an apparatus which may be implemented as an application server. The apparatus may comprise a transmitting unit, a receiving unit and a providing unit. In accordance with some exemplary embodiments, the transmitting unit may be operable to carry out at least the transmitting step of the method according to the thirteenth aspect of the present disclosure. The receiving unit may be operable to carry out at least the receiving step of the method according to the thirteenth aspect of the present disclosure. The providing unit may be operable to carry out at least the providing step of the method according to the thirteenth aspect of the present disclosure.

According to various exemplary embodiments, a group message may be converted into a file and delivered to one or more UEs over MBMS/MBS, and the one or more UEs can obtain meta data of the file from an application server via service announcement, so that the file can be understood by the one or more UEs properly with the meta data. This can enhance the efficiency and flexibility of group message delivery using MBMS/MBS.

### BRIEF DESCRIPTION OF THE DRAWINGS

The disclosure itself, the preferable mode of use and further objectives are best understood by reference to the following detailed description of the embodiments when read in conjunction with the accompanying drawings, in which:

FIG. 1 is a diagram illustrating exemplary delivery methods according to an embodiment of the present disclosure;

FIG. 2A is a diagram illustrating an exemplary MBS reference architecture according to an embodiment of the present disclosure;

FIG. 2B is a diagram illustrating an exemplary 5G system architecture for MBS using the reference point representation according to an embodiment of the present disclosure;

FIG. 2C is a diagram illustrating an exemplary interworking system architecture according to an embodiment of the present disclosure;

FIG. 3A is a diagram illustrating exemplary MBS session creation without policy and charging control (PCC) according to an embodiment of the present disclosure;

FIG. 3B is a diagram illustrating exemplary MBS session creation with PCC according to an embodiment of the present disclosure;

FIG. 3C is a diagram illustrating exemplary MBS session establishment for broadcast according to an embodiment of the present disclosure;

FIG. 3D is a diagram illustrating exemplary group message delivery using MBMS according to an embodiment of the present disclosure;

FIG. 3E is a diagram illustrating an exemplary building block structure of file delivery over unidirectional transport (FLUTE) according to an embodiment of the present disclosure;

FIGS. 3F-3G are diagrams illustrating exemplary session start procedures according to some embodiments of the present disclosure;

FIG. 4A is a diagram illustrating exemplary group message delivery over MBMS in EPS according to an embodiment of the present disclosure;

FIG. 4B is a diagram illustrating exemplary group message delivery over MBS broadcast in 5GS according to an embodiment of the present disclosure;

FIG. 4C is a diagram illustrating exemplary group message delivery over MBMS and MBS broadcast according to an embodiment of the present disclosure;

FIGS. 5A-5D are flowcharts illustrating various methods according to some embodiments of the present disclosure;

FIG. 6 is a block diagram illustrating an apparatus according to an embodiment of the present disclosure; and

FIG. 7A-7D are block diagrams illustrating various apparatus according to some embodiments of the present disclosure.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the terms “first”, “second” and so forth refer to different elements. The singular forms “a” and “an” are intended to include the plural forms as well, unless the context clearly indicates otherwise. The terms “comprises”, “comprising”, “has”, “having”, “includes” and/or “including” as used herein, specify the presence of stated features, elements, and/or components and the like, but do not preclude the presence or addition of one or more other features, elements, components and/or combinations thereof. The term “based on” is to be read as “based at least in part on”. The term “one embodiment” and “an embodiment” are to be read as “at least one embodiment”. The term “another embodiment” is to be read as “at least one other embodiment”. Other definitions, explicit and implicit, may be included below.

Architectural enhancements to the fifth generation (5G) system using new radio (NR) to support multicast and broadcast communication services are specified by 3GPP. The MBS architecture defined in clause 5 of 3GPP TS 23.247 v17.1.0 follows the 5GS architectural principles as defined in 3GPP TS 23.501 v17.3.0, enabling distribution of the MBS data from the 5GS ingress to next generation-radio access network (NG-RAN) node(s) and then to a UE. The MBS architecture may provide efficient usage of radio access network (RAN) and core network (CN) resources, with an emphasis on radio interface efficiency; and provide efficient transport for a variety of multicast and broadcast services. Multicast-broadcast service for roaming is not supported in this release. Interaction between multicast-broadcast service and support of deployments topologies with specific SMF service areas is not specified in this release.

The MBS may also provide functionalities such as local MBS service, authorization of multicast MBS and quality of service (QOS) differentiation, e.g., as described in clause 6 of 3GPP TS 23.247 v17.1.0. MBS traffic may be delivered from a single data source (e.g. an application service provider) to multiple UEs. Depending on many factors, there may be several delivery methods which may be used to deliver the MBS traffic in the 5GS. For clarity, delivery methods are not referred to as unicast/multicast/broadcast but as described in 3GPP TS 23.247 v17.1.0. The term “unicast delivery” refers to a mechanism by which application data and signaling between the UE and the application server are delivered using packet data unit (PDU) session within the 3GPP network and using individual UE and application server addresses (e.g., Internet protocol (IP) addresses) between the 3GPP network and the application server. It may not be equivalent to 5G core (5GC) individual MBS traffic delivery method defined in 3GPP TS 23.247 v17.1.0.

Between 5GC and NG-RAN, there are two possible delivery methods as below to transmit the MBS data:
5GC individual MBS traffic delivery method: This method is only applied for multicast MBS session. 5GC receives a single copy of MBS data packets and delivers separate copies of those MBS data packets to individual UEs via per-UE PDU sessions, hence for each such UE one PDU session is required to be associated with a multicast session.
5GC shared MBS traffic delivery method: This method is applied for both broadcast and multicast MBS session. 5GC receives a single copy of MBS data packets and delivers a single copy of those MBS packets to an NG-RAN node, which then delivers the packets to one or multiple UEs.

The 5GC shared MBS traffic delivery method may be required in all MBS deployments. The 5GC individual MBS traffic delivery method may be required to enable mobility when there is an NG-RAN deployment with non-homogeneous support of MBS.

For the multicast session, a single copy of MBS data packets received by the CN may be delivered via 5GC individual MBS traffic delivery method for some UE(s) and via 5GC shared MBS traffic delivery method for other UEs.

Between the NG-RAN and the UE, two delivery methods may be available for the transmission of MBS data packets over radio interface:
Point-to-Point (PTP) delivery method: NG-RAN delivers separate copies of MBS data packets over radio interface to individual UE(s).
Point-to-Multipoint (PTM) delivery method: NG-RAN delivers a single copy of MBS data packets over radio interface to multiple UEs.

NG-RAN may use a combination of PTP/PTM to deliver an MBS data packets to UEs. The PTP and PTM delivery methods are defined in RAN WGs.

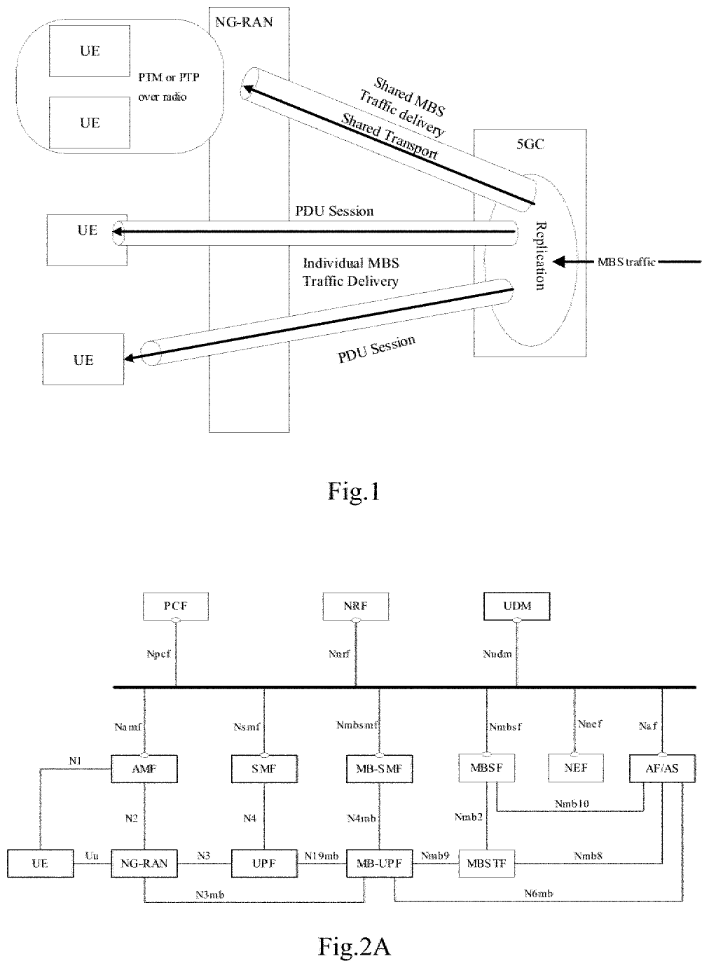

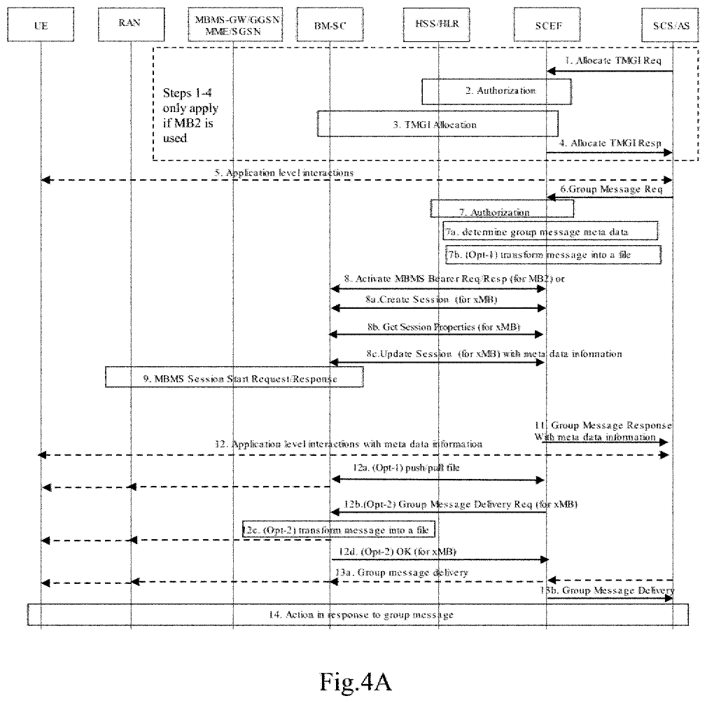

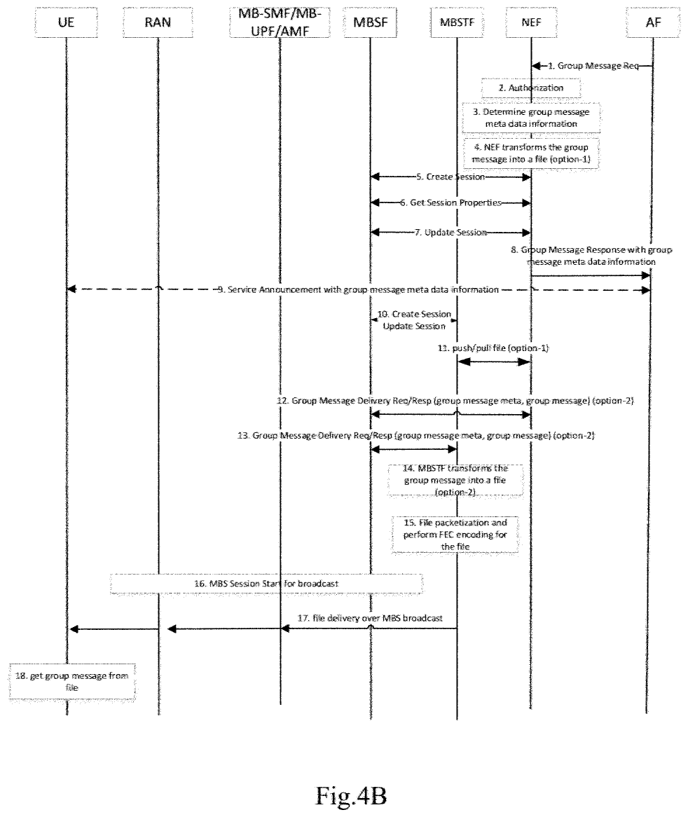

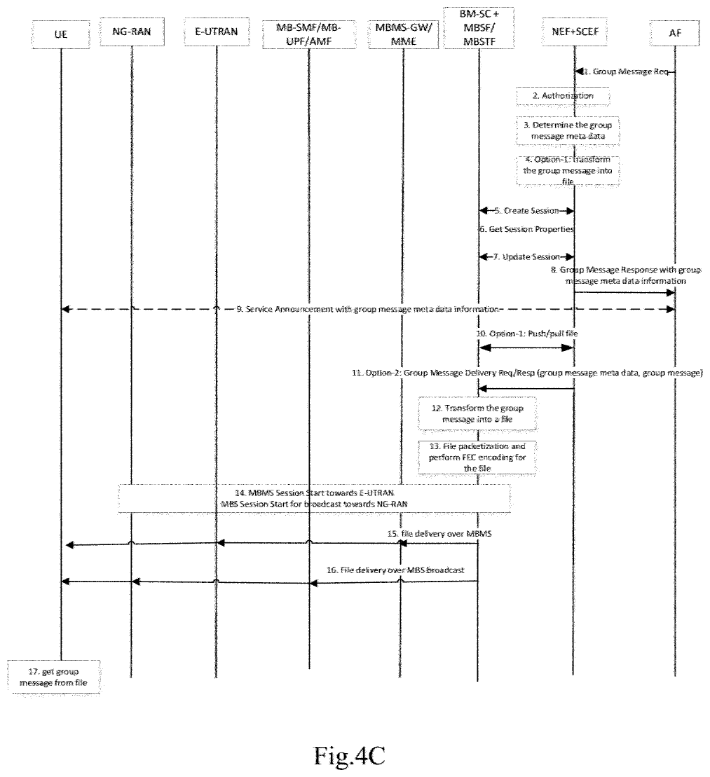

FIG. 1 is a diagram illustrating exemplary delivery methods according to an embodiment of the present disclosure. As depicted in FIG. 1 (which may correspond to FIG. 4.1-1 of 3GPP TS 23.247 v17.1.0), 5GC shared MBS traffic delivery method (with PTP or PTM delivery) and 5GC individual MBS traffic delivery method may be used at the same time for a multicast MBS session. For MBS broadcast communication, only 5GC shared MBS traffic delivery method with PTM delivery is applicable. For MBS multicast communication, if the NG-RAN node supports MBS, the network may need to use the 5GC shared MBS traffic delivery method for MBS data transmission. The exception is when the UE moves between NG-RAN node not supporting MBS (with 5GC individual MBS traffic delivery method) and NG-RAN node supporting MBS, there is temporary co-existence between 5GC shared MBS traffic delivery method and 5GC individual MBS traffic delivery method, e.g., as described in clause 6.3 of 3GPP TS 23.247 v17.1.0.

For MBS multicast communication, the switching between 5GC shared MBS traffic delivery method and 5GC individual MBS traffic delivery method may be supported. The UE mobility between RAN nodes both supporting MBS, and between a RAN node supporting MBS and a RAN node not supporting MBS may be supported, e.g., as described in clause 6.3 of 3GPP TS 23.247 v17.1.0.

For MBS multicast communication, the switching between PTP and PTM delivery methods for 5GC shared MBS traffic delivery may be supported. NG-RAN is the decision point for switching between PTP and PTM delivery methods.

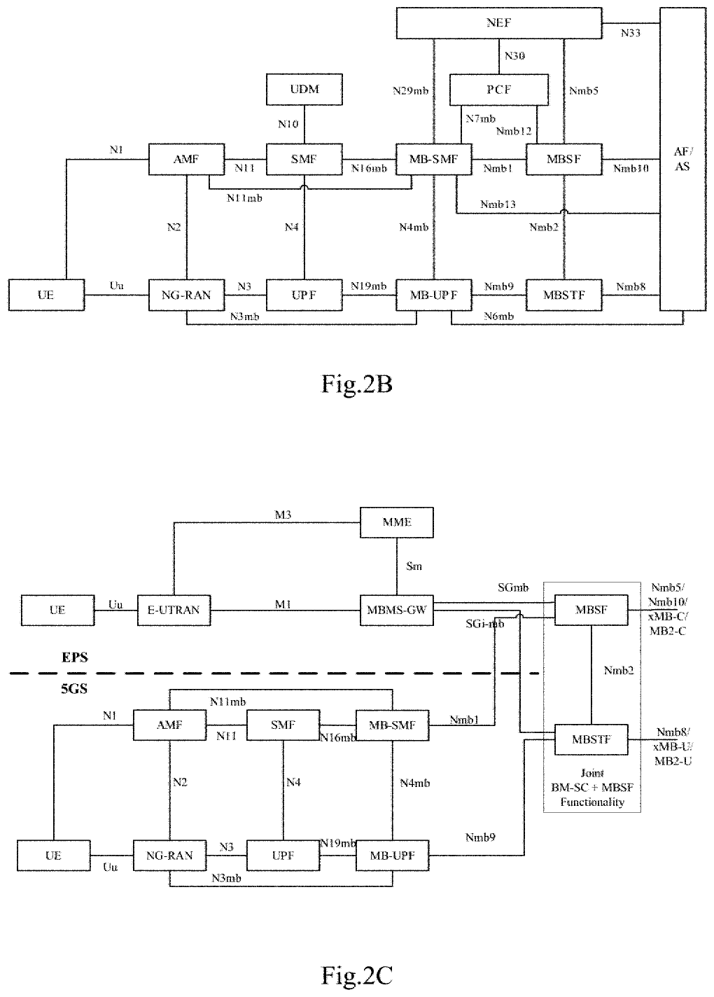

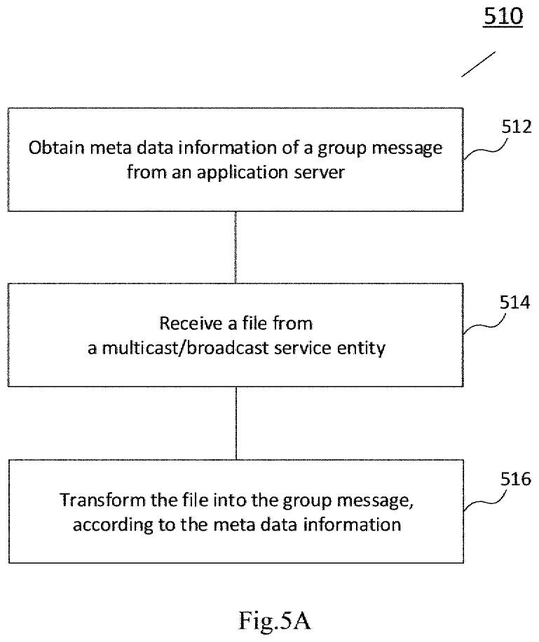

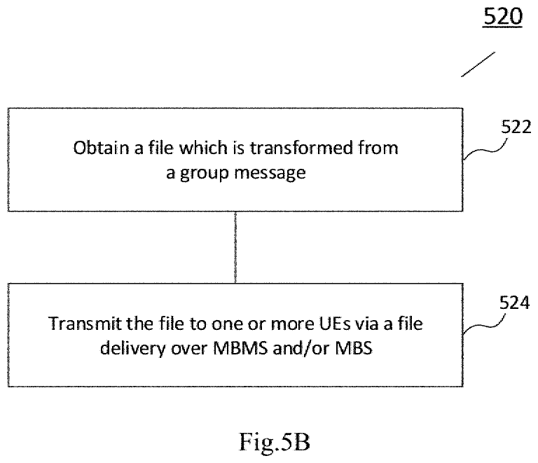

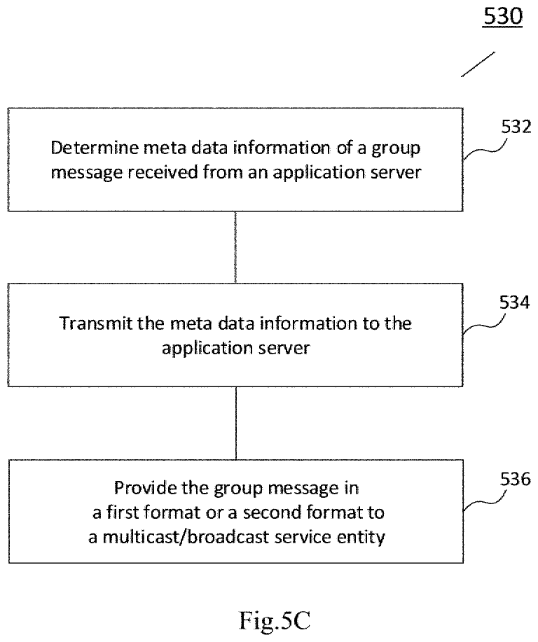

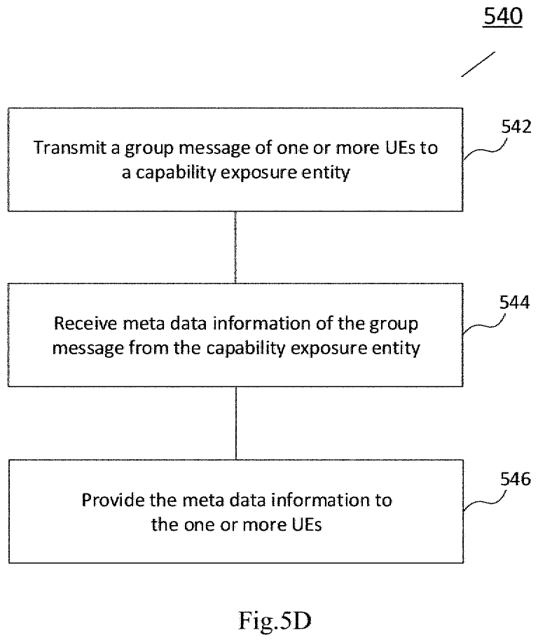

FIG. 2A is a diagram illustrating an exemplary MBS reference architecture according to an embodiment of the present disclosure. The MBS reference architecture shown IN FIG. 2A may correspond to a 5G system architecture for MBS as illustrated in FIG. 5.1-1 of 3GPP TS 23.247 v17.1.0. In this general architecture, service-based interfaces may be used within the control plane. Annex C of 3GPP TS 23.247 v17.1.0 describes support for interworking at reference points xMB and MB2. It is noted that the MBSF is optional and may be collocated with the NEF or AF/AS, and the multicast/broadcast service transport function (MBSTF) may be an optional network function. The existing service-based interfaces of Nnrf, Nudm, and Nsmf may be enhanced to support MBS. The existing service-based interfaces of Npcf and Nnef may also be enhanced to support MBS. An MBS-enabled AF may use either Nmbsf or Nnef to interact with the MBSF.

FIG. 2B is a diagram illustrating an exemplary 5G system architecture for MBS using the reference point representation according to an embodiment of the present disclosure. The exemplary 5G system architecture for MBS shown in FIG. 2B may correspond to a 5G system architecture for MBS as illustrated in FIG. 5.1-2 of 3GPP TS 23.247 v17.1.0. In this 5G system architecture, the existing reference points of N1, N2, N4, N10, N11, N30 and N33 may be enhanced to support MBS. Regarding the functionalities, Nmb13, N29mb and Nmb1 are identical, Nmb5 and Nmb10 are identical, Nmb9 and N6mb are identical.

FIG. 2C is a diagram illustrating an exemplary interworking system architecture according to an embodiment of the present disclosure. Interworking between MBS and evolved multimedia broadcast/multicast service (eMBMS) at service layer functionality applies in some cases where the same multicast/broadcast service is provided via eMBMS and MBS. The MBS-eMBMS interworking system architecture at service layer as shown in FIG. 2C may be implemented as a general architecture for interworking with evolved packet system (EPS), corresponding to FIG. 5.2-1 of 3GPP TS 23.247 v17.1.0, i.e., a system architecture for interworking between evolved-universal terrestrial radio access network/evolved packet core (E-UTRAN/EPC) eMBMS and MBS at service layer, with collocated broadcast/multicast-service center (BM-SC) and MBSF/MBSTF functionalities. The BM-SC+MBSF/MBSTF may expose common Nmb5/Nmb10/xMB-C/MB2-C and Nmb8/xMB-U/MB2-U reference points to the NEF and/or AF/AS. A common TMGI may be used towards the AF/AS. The TMGI may also be used as identifier for transport over E-UTRAN/EPC. It is noted that MB2-C/U may be both legacy reference points and 5GS reference points.

In accordance with an exemplary embodiment, an AF may use an MBS session creation procedure to start an MBS session towards 5GC. This procedure may consist of TMGI allocation and MBS session creation, and they may be applicable to both multicast and broadcast communications unless otherwise stated. As described in clause 7.1.1.2 of 3GPP TS 23.247 v17.1.0, for multicast, MBS session establishment procedure triggered by UE join requests may follow the MBS session creation procedure to reserve resources towards NG-RAN. For broadcast, the MBS session start procedure to reserve resources towards NG-RAN may be triggered by the MBS session creation procedure. For both broadcast and multicast communication, the TMGI allocation may be separated from the MBS session creation request. For multicast communication, the TMGI allocation procedure may be applicable if a TMGI is used as an MBS session ID.

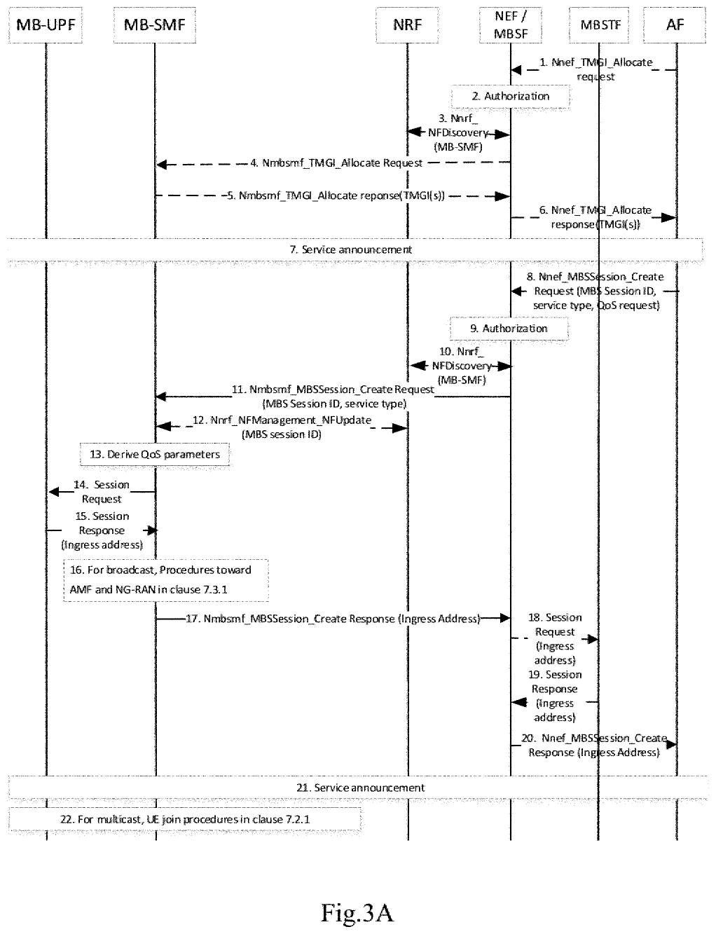

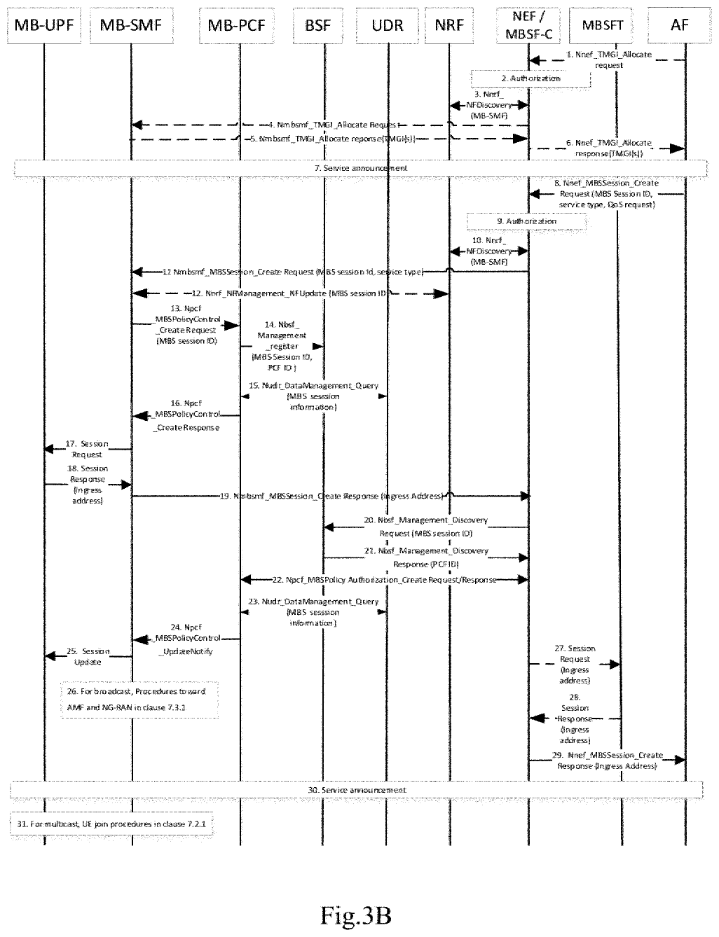

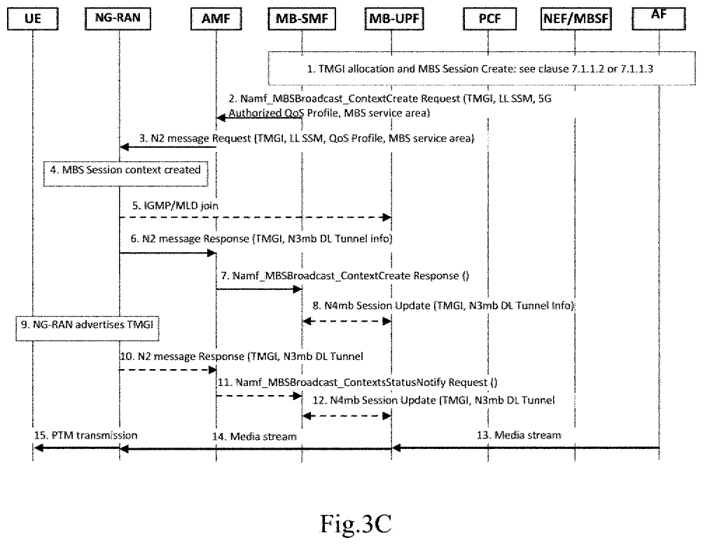

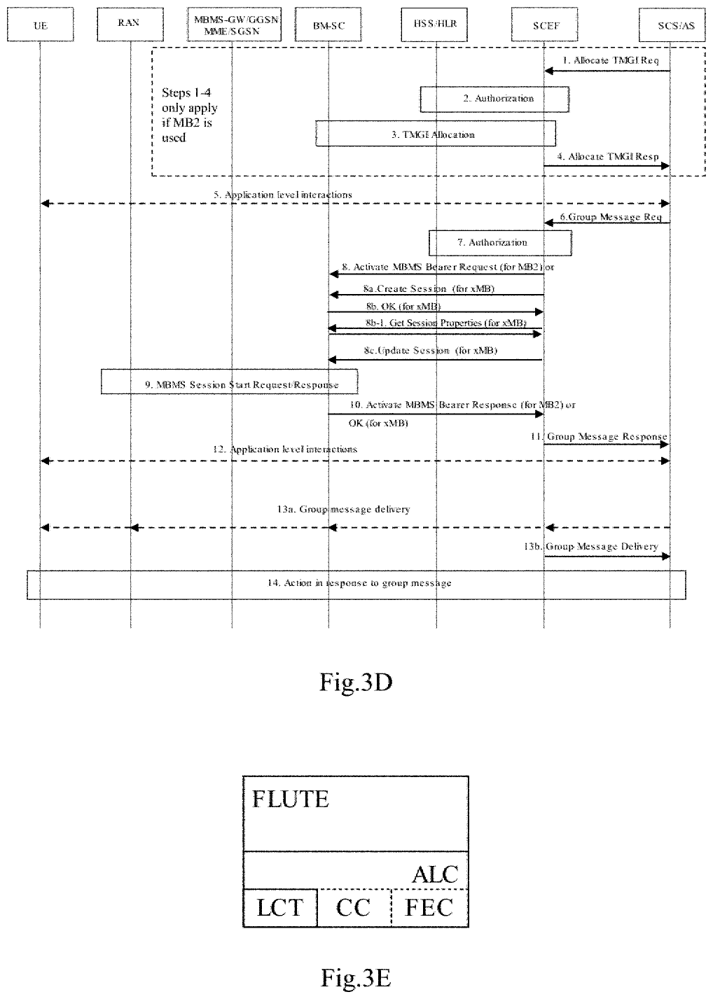

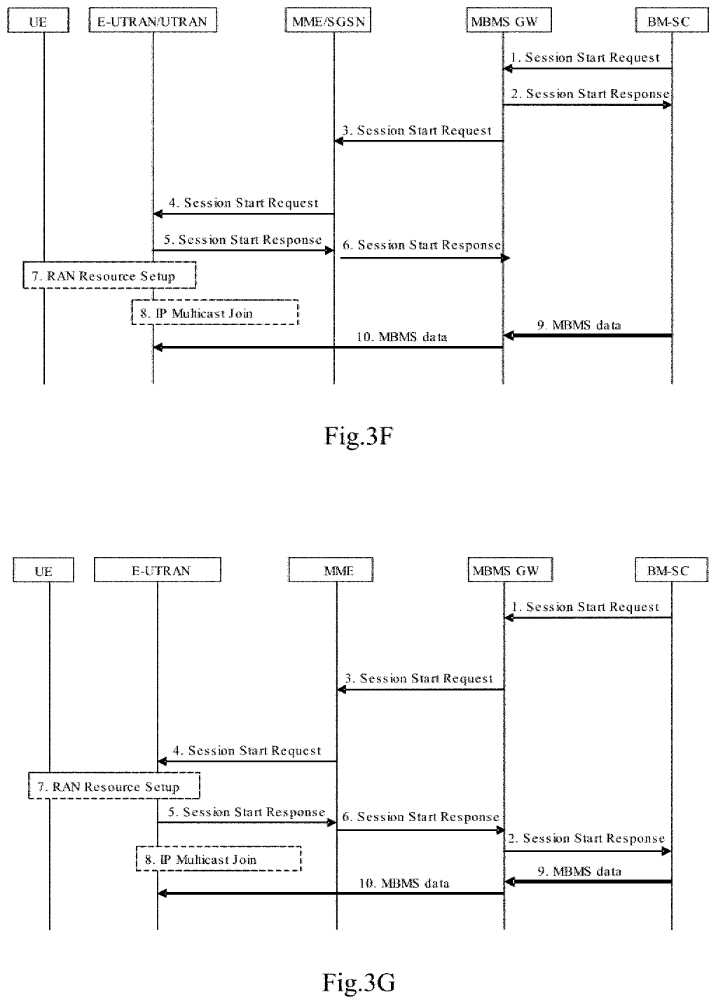

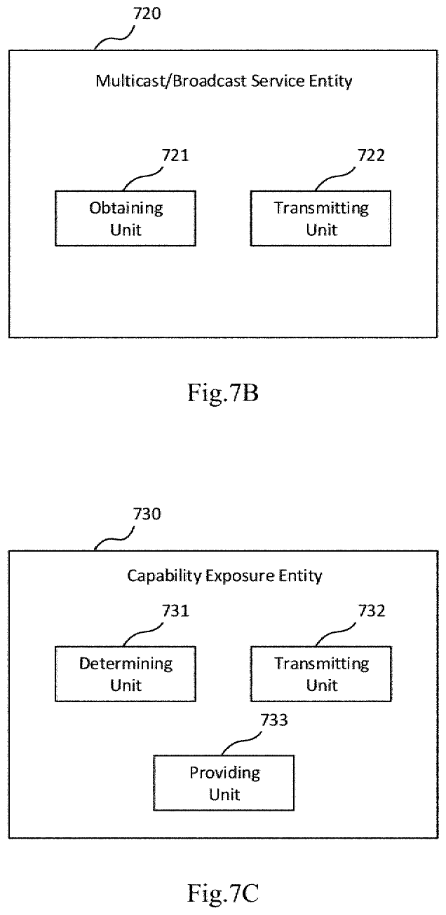

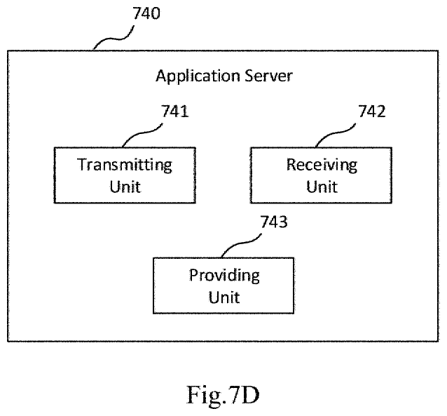

FIG. 3A is a diagram illustrating exemplary MBS session creation without PCC according to an embodiment of the present disclosure. Some network elements such as a multicast/broadcast user plane function (MB-UPF), an MB-SMF, an NRF, an NEF/MBSF, an MBSTF and an AF may be involved in the exemplary procedure illustrated in FIG. 3A. It can be appreciated that network elements and signaling messages shown in FIG. 3A are just as examples, and more or less alternative network elements and signaling messages may be involved in the MBS session creation procedure according to various embodiments of the present disclosure. The exemplary procedure shown in FIG. 3A may correspond to a procedure of MBS session creation without PCC as illustrated in FIG. 7.1.1.2-1 of 3GPP TS 23.247 v17.1.0, and include the following steps:
1. The AF may send an Nnef_TMGI Allocate Request (TMGI number) message to the NEF/MBSF to request allocation of a TMGI(s) to identify new MBS session(s). It is noted that depending on the network deployment and use case, the MB-SMF may receive one or more requests from the AF directly, or via the NEF, or via the MBSF, or via a combination of NEF and MBSF.
2. The NEF may check authorization of the AF. It is noted that the NEF may not be required if the AF is in trusted domain.
3. The NEF/MBSF may discover and select an MB-SMF using the NRF or based on local configuration.
4. The NEF/MBSF may send an Nmbsmf_TMGI_Allocate Request (TMGI number) message to the MB-SMF.
5. The MB-SMF may allocate TMGI(s) and return the TMGI(s) to the NEF/MBSF via the Nmbsmf_TMGI_Allocate Response (TMGI(s), expiration time).
6. The NEF and/or the MBSF may respond to the AF by sending an Nnef_TMGI_Allocate Response (TMGI(s), expiration time).
7. The AF may perform a service announcement towards UEs. The AF may inform the UEs about MBS session information with MBS session ID, e.g., TMGI, source specific IP multicast address (SSM), and possibly other information e.g., MBS service area information, session description information, etc. The MBS service area information may be a cell ID list, a TAI list, geographical area information and/or civic address information. Amongst them, the cell ID list and the TAI list may only be used by AFs who reside in trust domain, and when the AFs are aware of such information. The UE may need to be aware if the service is broadcast or multicast to decide if JOIN is to be performed.
8. The AF of content provider may provide description for an MBS session (possibly providing information for a previously allocated TMGI to NEF via an Nnef_MBSSession_Create request ([MBS session ID], service type, MBS information, [TMGI allocation indication]). If steps 1-6 have not been executed before, the AF may provide an SSM or it may request that the network allocates an identifier for the MBS session (i.e., TMGI). The AF may provide the service type (i.e. either multicast service or broadcast service). The MBS session information may further include QoS requirements and Any UE indication (indicating whether a multicast MBS session is “open to any UEs”), MBS service area information, start and end time of the MBS session and MBS session state (active/inactive). In addition, the MBS information may also indicate whether the allocation of an ingress transport address is requested. If geographical area information or civic address information is provided by the AF as MBS service area information, the NEF/MBSF may translate the MBS service area information into a cell ID list or a TAI list.
9. The NEF/MBSF may check authorization of the content provider.
10. The NEF/MBSF may discover MB-SMF candidates and select an MB-SMF as an ingress control node, possibly based on MBS service area information. If a TMGI is included in step 8, the NEF/MBSF may find the MB-SMF based on that TMGI.
11. The NEF/MBSF may send an Nmbsmf_MBSSession_Create Request (MBS session ID, service type, TMGI allocation indication, MBS service area information, ingress transport address request indication) to the MB-SMF, to request the MB-SMF to reserve ingress resources for an MBS distribution session. The NEF/MBSF may provide an MBS session ID or request allocation of a TMGI, and indicate the requested service type (either multicast service or broadcast service) and MBS session state (active/inactive). It may also indicate that the allocation of an ingress transport address is requested if this is requested in step 8, or if the MBSF decides to insert an MBSTF into the user plane for the MBS session. The request may also include the Any UE indication if provided in step 8. The MBS service area information may be provided by the NEF/MBSF to the MB-SMF if provided by the AF in step 8.
12. If requested to do so, or if a source specific multicast is provided as the MBS session ID in step 11, the MB-SMF may allocate a TMGI. If a source specific multicast is provided as the MBS session ID in step 11, the MB-SMF may update its network function (NF) profile at the NRF with the serving MBS session ID. If the MBS service area information is received in step 11, the MB-SMF may update its NF profile at the NRF with that information. It is noted that if the TMGI is used to represent an MBS session, the MB-SMF may not need to update the NRF if the TMGI range(s) supported by the MB-SMF is already included in the MB-SMF profile when the MB-SMF registers itself into the NRF.
13. The MB-SMF may derive the required QoS parameters locally.
14. The MB-SMF may select the MB-UPF. If the allocation of an ingress transport address is requested in step 11, the MB-SMF may request the MB-UPF to reserve user plane ingress resources. If multicast transport of the MBS data towards RAN nodes is to be used, the MB-SMF may also request the MB-UPF to reserve for the outgoing data a tunnel endpoint and the related identifiers (source IP address, SSM and general packet radio service tunneling protocol (GTP) tunnel ID) and to forward data received at the user plane ingress resource using that tunnel endpoint. If the allocation of an ingress transport address is not requested in step 11, the MB-SMF may provide the SSM received as MBS session ID to the MB-UPF and request the MB-UPF to join the corresponding multicast tree from the content provider. The MB-SMF may also defer the configuration to join the corresponding multicast tree e.g., based on information that the session is inactive, QoS requirements and MBS start/end time until receiving the first query for the MBS session as part of the establishment procedure (e.g., as described in clause 7.2.1.3 of 3GPP TS 23.247 v17.1.0), or until receiving a request to activate the MBS session via the MBS session update procedure (e.g., as described in clause 7.1.1.6 or 7.1.1.7 of 3GPP TS 23.247 v17.1.0).
15. If requested, the MB-UPF may select an ingress address (IP address and port) and a tunnel endpoint for the outgoing data and provide it to the MB-SMF.
16. For broadcast communication, the MB-SMF may continue the procedure towards the access and mobility management function (AMF) and NG-RAN (e.g., as described in clause 7.3.1 of 3GPP TS 23.247 v17.1.0).
17. The MB-SMF may indicate the possibly allocated ingress address to the NEF/MBSF. The MB-SMF may include TMGI if it is allocated in step 9. It may also indicate the success or failure of reserving transmission resources.
18. [Optional] If the MBSF decides to use an MBSTF, the NEF/MBSF may provide the ingress address received in step 14 towards the MBSTF as downlink (DL) destination. If the allocation of an ingress transport address is requested in step 8, the MBSF may request the MBSTF to allocate the user plane ingress resources. If the allocation of an ingress transport address is not requested in step 8, the MBSF may provide the SSM received as multicast session ID in step 8 and request the MBSTF to join the corresponding multicast tree from the content provider.
19. [Conditional on step 18] If requested, the MBSTF may select an ingress address (IP address and port) and provide it to the NEF/MBSF.
20. The NEF/MBSF-C may indicate the possibly allocated ingress address and other parameters (e.g. TMGI) to the AF via an Nnef_MBSSession_Create response ([TMGI], [Allocated ingress address])). If the MBS session ID is not provided in step 8, or the MBS session ID is SSM, the NEF/MBSF may provide the allocated TMGI. If the AF requests the allocation of an ingress transport address, the message may also include the allocated ingress address.
21. Same as step 7. The AF may also perform a service announcement at this stage.
22. For multicast communication, depending on configuration the UEs can join the MBS session (e.g., as described in clause 7.2.1 of 3GPP TS 23.247 v17.1.0).

It can be appreciated that steps 1-6 as illustrated in FIG. 3A may be optional and only applicable if TMGI is used as MBS session ID and required to be pre-allocated.

FIG. 3B is a diagram illustrating exemplary MBS session creation with PCC according to an embodiment of the present disclosure. Some network elements such as an MB-UPF, an MB-SMF, a multicast/broadcast policy charging function (MB-PCF), a binding support function (BSF), a unified data repository (UDR), an NRF, an NEF/MBSF-C, an MBSTF and an AF may be involved in the exemplary procedure illustrated in FIG. 3B. It can be appreciated that network elements and signaling messages shown in FIG. 3B are just as examples, and more or less alternative network elements and signaling messages may be involved in the MBS session creation procedure according to various embodiments of the present disclosure. The exemplary procedure shown in FIG. 3B may correspond to a procedure of MBS session creation with PCC as illustrated in FIG. 7.1.1.3-1 of 3GPP TS 23.247 v17.1.0, and include the following steps:
1 to 10. Same as steps 1-10 shown in FIG. 3A. Step 1 shown in FIG. 3B may include an application ID.
11. Same as step 11 shown in FIG. 3A. In addition, the NEF/MBSF may decide based on local configuration or based on parameters received in step 8 (e.g., whether the session comprises several data flows) whether it will invoke the Npcf_MBSPolicy Authorization service for the MBS session. If so, the NEF/MBSF may indicate to the MB-SMF that it will also provide a policy authorization for the MBS session to the PCF.
12. Same as step 12 shown in FIG. 3A.
13. [Optional] If the NEF/MBSF indicated in step 11 that it will also provide a policy authorization for the broadcast session to the PCF, the MB-SMF may select a PCF and send an Npcf_MBSPolicyControl_Create Request (MBS session ID) for the MBS session towards the PCF, and defer step 25 until receiving an Npcf_MBSPolicyControl_UpdateNotify for the MBS session. Otherwise, the MB-SMF may decide based on local configuration whether to invoke the Npcf_MBSPolicyControl service.
14. [Conditional on step 13] The PCF may register at the BSF that it handles the MBS session by using Nbsf_management_Register Request (MBS session ID, PCF ID). It may provide an identifier that the policy association is for MBS and the MBS session ID, its own PCF ID and optionally its PCF set ID.
15. [Optional] The PCF may retrieve preconfigured policy information for the MBS session based on the multicast address as multicast session ID (e.g., applicable QoS, the MBS Session-Aggregated Maximum Bit Rate (AMBR) and/or default 5G QoS indicator (5QI )) from the UDR.
16. [Conditional on step 13] The PCF may respond with an Npcf_MBSPolicyControl_Create Response (MBS policy, e.g., as described in clause 6.10 of 3GPP TS 23.247 v17.1.0) with policies for the MBS session ID. The MBS policy may include the session-AMBR for the MBS session and 5QI for the MBS QoS flow.
17-18. Same as steps 14-15 in FIG. 3A.
19. Same as step 17 in FIG. 3A.
20-21. [Optional] The NEF/MBSF may use the BSF discovery service to discover the PCF serving the MBS session with the MBS session ID by using Nbsf_management_Discovery operation.
22. [Optional] The NEF/MBSF may send an Npcf_MBSPolicy Authorization_Create Request to the PCF with the MBS session ID and MBS session information (that may include an application ID). The PCF may determine whether the request is authorized. If the request is authorized, the PCF may derive the required QoS parameters based on the information provided by the NEF and determine whether this QOS is allowed (e.g., according to the policy input configuration in the UDR). If the request is not authorized or the required QoS is not allowed, the PCF may indicate so in the response to the NEF.
23. [Optional] The PCF may perform data management with the UDR via Nudr_DataManagement_Query.
24. [Conditional] If the PCF determines updated policies for the MBS session in step 21, it may update the policy information at the MB-SMF. When obtaining a request for the creation of a policy association (signal 21) for a broadcast session, for which it already performs policy control towards an MB-SMF, the PCF may always provide a policy update to the MB-SMF; if no real policy update is required, the PCF may repeat previous policies or send an empty update message.
25. [Conditional] If required by the updated policies, the MB-SMF may update the MB-UPF accordingly.
26. When obtaining an MBS policy control update from the PCF (signal 23) for a broadcast session, the MB-SMF may continue the procedure towards the AMF and NG-RAN (e.g., as described in clause 7.3.1 of 3GPP TS 23.247 v17.1.0) to request the allocation of resources to for the transmission of the broadcast session.
27-31. Same as steps 18-22 in FIG. 3A. It is noted that steps 27-31 may be executed in parallel to steps 20-26.

It can be appreciated that steps 1-7 as illustrated in FIG. 3B may be optional and only applicable if TMGI is used as MBS session ID and required to be pre-allocated.

According to the contents about MBS session start for broadcast described in clause 7.3.1 of 3GPP TS 23.247 v17.1.0, the broadcast session start procedure may follow the common procedure as described in clause 7.1.1.2 or clause 7.1.1.3 of 3GPP TS 23.247 v17.1.0, which may consist of TMGI allocation and MBS session create as illustrated in FIG. 3A and FIG. 3B. It may be possible for the AF to allocate TMGI once but create the MBS session for multiple times. A combined procedure to perform both TMGI allocation and MBS session create may be available.

The TMGI allocation may be used by the AF to obtain the TMGI as MBS session ID (i.e. TMGI) and perform service announcement towards UEs. The MBS session create (with MBS service type set to broadcast service) may be used by the AF to indicate the impending start of the transmission of MBS data, and to provide the session attributes, so that resources for the MBS session are set up in the MB-UPF and in the NG-RAN for 5GC shared MBS traffic delivery. The MBS session create can be used if the TMGI has not been allocated. In this case, the MB-SMF may allocate a unique TMGI for the AF and then start the MBS session. It is noted that when the multicast transport between NG-RAN and MB-UPF is described below, source specific multicasting is assumed.

To receive the data of broadcast communication service, the UE may be either preconfigured with needed configuration (e.g., user service description (USD) as defined in 3GPP TS 26.346 v16.9.1) for the UE to receive MBS service, or provisioned with the configuration of broadcast session on application level (service announcement; the configuration may for instance be performed using session initiation protocol (SIP) signaling, or methods described in 3GPP TS 26.346 v16.9.1). If the needed configuration is pre-configured, the UE may not need to interact with the network.

FIG. 3C is a diagram illustrating exemplary MBS session establishment for broadcast according to an embodiment of the present disclosure. Some network elements such as a UE, an NG-RAN, an AMF, an MB-SMF, an MB-UPF, a PCF, an NEF/MBSF and an AF may be involved in the exemplary procedure illustrated in FIG. 3C. It can be appreciated that network elements and signaling messages shown in FIG. 3C are just as examples, and more or less alternative network elements and signaling messages may be involved in the MBS session establishment for broadcast according to various embodiments of the present disclosure. The exemplary procedure shown in FIG. 3C may correspond to a procedure of MBS session establishment for broadcast as illustrated in FIG. 7.3.1-1 of 3GPP TS 23.247v17.1.0, and include the following steps:
1. To establish broadcast MBS session, the AF may perform TMGI allocation and MBS session creation as specified in clause 7.1.1.2 or 7.1.1.3 of 3GPP TS 23.247 v17.1.0. The MBS service type indicates to be broadcast service.
2. The MB-SMF may use the NRF to discover the AMF(s) supporting MBS based on the MBS service area and select the appropriate one(s). Then the MB-SMF sends the Namf_MBSBroadcast_ContextCreate (TMGI, LL SSM, 5G QOS Profile, MBS service area) messages to the selected AMF(s) in parallel if the service type is broadcast service. The MB-SMF may include a maximum response time in the request.
3. The AMF may transfer the N2 message in the received Namf_MBSBroadcast_ContextCreate Request (TMGI, LL SSM, N2 SM information (5G QoS Profile)) message to all NG-RANs which support MBS in the MBS service area. The AMF may include the MBS service area.
4. The NG-RAN may create a broadcast MBS session context, and store the TMGI, the QoS profile in the MBS session context. The LL SSM are optional parameters and only provided by the MB-SMF to the NG-RAN if N3mb multicast transport is configured to be used in the 5GC.
5. If the NG-RAN prefers to use N3mb multicast transport (and if LL SSM is available in NG-RAN), the NG-RAN may join the multicast group (i.e. LL SSM). If the NG-RAN prefers to use N3mb point-to-point transport (or if the LL SSM is not available in NG-RAN) between the NG-RAN and the MB-UPF, the NG-RAN may provide its N3mb DL Tunnel Info.
6. The NG-RAN may report successful establishment of the MBS session resources (which may include multiple MBS QoS flows) by sending MBS Session Resource Setup Response (TMGI, N2 SM information (N3mb DL Tunnel Info)) message(s) to the AMF. N3mb DL Tunnel Info may be only available when point-to-point transport applies between the MB-UPF and the NG-RAN. The NG-RAN may report in N2 SM container partially successful result, if not all MBS session resources (i.e. all MBS QoS flows admitted) are established successfully in all requested cells.
7. The AMF may transfer the Namf_MBSBroadcast_ContextCreate Response ( ) to the MB-SMF. The AMF may need to respond success when it receives the first success response from the NG-RAN(s). And if all NG-RAN(s) report failure, the AMF may need to respond failure. The MB-SMF may store the AMF(s) which responds success in the MBS session context as the downstream nodes. If the AMF receives the NG-RAN response from all involved NG-RAN(s), the AMF may need to include an indication of completion of the operation in all NG-RANs.
8. If N3mb point-to-point transport is to be used (i.e. N3mb DL Tunnel Info is present in the Namf_MBSBroadcast_ContextCreate Response message from AMF), the MB-SMF may send an N4mb Session Modification Request to the MB-UPF to allocate the N3mb point-to-point transport tunnel for a replicated MBS stream for the MBS session. Otherwise, step 8 can be skipped.
9. The NG-RAN may advertise the TMGI representing the MBS service over radio interface. Step 9 can take place in parallel with step 6.
10. Another NG-RAN may report successful establishment of the MBS session resources (which may include multiple MBS QOS flows) by sending MBS Session Resource Setup Response (TMGI, N2 SM information (N3mb DL Tunnel Info)) message after the AMF transferred the Namf_MBSBroadcast_ContextCreate Response ( ) to the MB-SMF.
11. The AMF may transfer the Namf_MBSBroadcast_ContextStatusNotify request ( ) to the MB-SMF. When the AMF receives the response from all NG-RAN nodes, the AMF may include an indication of the completion of the operation. If the AMF does not receive responses from all NG-RAN nodes before the maximum response time elapses since the reception of the Namf_MBSBroadcast_ContextCreate Request, then the AMF may need to transfer the Namf_MBSBroadcast_ContextStatusNotify request ( ) which indicates partial success or failure.
12. If N3mb point-to-point transport is to be used (i.e. N3mb DL Tunnel Info is present in the MBS Session Start Response message from AMF), the MB-SMF may send an N4mb Session Modification Request to the MB-UPF to allocate the N3mb point-to-point transport tunnel for a replicated MBS stream for the MBS Session. Otherwise, step 12 can be skipped.
13. The AF may start transmitting the DL media stream to MB-UPF using the N6mb Tunnel, or optionally un-tunneled i.e. as an IP multicast stream using the HL MC address.
14. The MB-UPF may transmit the media stream to the NG-RAN via N3mb multicast transport or point-to-point transport.
15. The NG-RAN may transmit the received DL media stream using DL PTM resources.

It is noted that steps 6-8 and steps 2-4 shown in FIG. 3C may be comparable to steps 2-5 and steps 6-7 as described in clause 7.2.1.4 of 3GPP TS 23.247 v17.1.0, respectively.

Currently, some topics about group message delivery are discussed in 3GPP, e.g., whether and how to support group message delivery for capability-limited devices, including NEF enhancement, coexistence of existing power saving mechanisms and MBS, which are the study items in SP-211645.

FIG. 3D is a diagram illustrating exemplary group message delivery using MBMS according to an embodiment of the present disclosure. The exemplary procedure shown in FIG. 3D may correspond to a procedure of group message delivery using MBMS as illustrated in FIG. 5.5.1-1 of 3GPP TS 23.682 v17.2.0. If reference point MB2 is used, the procedure of group message delivery using MBMS may include the following steps:
1. If there is no assigned TMGI for an External Group ID, the SCS/AS may send the Allocate TMGI Request (External Group ID, SCS Identifier, (optional) location information, Accuracy) message to the service capability exposure function (SCEF). The SCS/AS may determine the IP address(es)/port(s) of the SCEF by performing a domain name system (DNS) query using the External Group ID or using a locally configured SCEF identifier/address. The location information restricts the distribution of the group message. It takes the format indicated in Accuracy parameter which can be either a list of cell IDs, or a list of MBMS Service Areas, or civic addresses, or a geographic area, or a combination of any of the above. Using the location information, the SCEF may check whether the SCS/AS is authorized to request TMGI allocation. If the expiration time for a previously allocated TMGI is to be extended, in addition to External Group ID, SCS Identifier and location/area information, the previously allocated TMGI may be included in the Allocate TMGI Request message. It is noted that a single SCEF can be connected to multiple BM-SCs in a given public land mobile network (PLMN). The location information may be used to identify BM-SC(s) to which MB2-C/U messages are to be sent to.
2. The SCEF may determine whether the SCS/AS is authorized to request TMGI allocation.
3. The SCEF may initiate TMGI allocation by the BM-SC (e.g., see TMGI Allocation Procedure specified in 3GPP TS 23.468 v16.0.0). In this procedure, if the TMGI is not included in step 1, the SCEF may request allocation of only one TMGI. If a TMGI is included in step 1, the SCEF may request to extend the TMGI expiration time for that TMGI. The SCEF may store TMGI and TMGI expiration received in this step.
4. The SCEF may send Allocate TMGI Response (Cause, TMGI, TMGI expiration) message to the SCS/AS. Cause value indicates success or failure of the requested procedure. In the case of failure, the reason for the failure condition is also included. The TMGI allocated by the BM-SC to which the SCS/AS is expected to send the group message, and TMGI expiration indicating the expiration time for the TMGI are also included. It is noted that the SCEF may cache the serving BM-SC identity information and mapping between External Group ID and TMGI. Steps 5-14 may be skipped if the SCS/AS only wants to extend the expiration time of the TMGI (MB2 only).
5. Application level interactions may be applied for the devices of specific group to retrieve the related MBMS service information, e.g. TMGI, start time, etc. in the case of MB2. Application level interactions between the UE and the SCS/AS are not discussed here. It is noted that if reference point xMB is used, steps 1-5 may be skipped.
6. The SCS/AS may send the Group Message Request (External Group Identifier, SCS Identifier, TMGI (MB2 only), Message Delivery Stop Time (xMB only), optional (Group Message Payload, location information, Accuracy, Message Delivery Start Time) message to the SCEF. In the case of xMB, the SCEF may create a service using xMB for the group message and associate the external Group Identifier with the HTTP REST resource identifier of the service provided by the BM-SC upon service creation. The then SCEF may forward either only the ServiceID (see Table 5.4-1 in 3GPP TS 26.348 v16.3.0) to the SCS/AS or all service announcement. After the service is created, the SCS/AS may trigger session creation towards the SCEF. The SCEF may assign a T8 long term transaction reference identifier (TLTRI) that identifies this group message delivery request. The location information may be included to identify the location over which group message is to be sent. It takes the format indicated in Accuracy parameter which can be either a list of cell IDs, or a list of MBMS Service Areas, or civic addresses, or a geographic area, or a combination of any of the above. The Message Delivery Start Time indicates the time at which the group message is to be sent by the network on the MBMS bearer(s). If not included, the group message is expected to be sent immediately. The Message Delivery Stop Time indicates the time at which the group message delivery is expected to be completed. When included, Group Message Payload indicates the payload the SCS/AS intends to deliver to UEs. Absence of Group Message Payload is indicative of the SCS/AS using delivery of group message in step 13a. It is noted that a single Group Message Payload can be sent to all included TMGIs (MB2 only). Whether actual payload or a reference to the payload (e.g., uniform resource identifier (URI)) is sent in this step is left to Stage 3. In the case of the latter, the SCEF may download the payload prior to step 13. In the case of xMB, if the application in the UE receives a ServiceId through application level interaction, the application can activate reception using MBMS device APIs (see 3GPP TS 26.347 v16.3.1).
7. The SCEF may check that the SCS/AS is authorized to send a group message request. It may also check to see if Message Delivery Start Time does not start after the TMGI expiration (MB2 only). In the case of xMB, the SCEF ensures that the xMB session stop time is not before the Message Delivery Start Time. If either of the checks fails, then the SCEF executes step 11 with a cause value indicating the reason for the failure condition and the flow stops at this step. In this case, the SCS/AS may subsequently release the TMGI allocated at step 3 by requesting an explicit de-allocation, or may rely on the expiration timer.
8. If MB2 is used, the Activate MBMS Bearer Procedure (see clause 5.1.2.3.2 of 3GPP TS 23.468 v16.0.0) may be executed with the following changes:
   In step 1 of this procedure, the SCEF, acting as group communication service (GCS) AS, may include location information from step 6. If no location information is provided in step 6 of this procedure, then the SCEF, based on local configuration, may use either a list of MBMS Service Area Identities, or a list of cell IDs, or both as the MBMS broadcast area.
   In step 2 of this procedure, the BM-SC may map the civic address(es) (if provided) and/or geographic area(s) (if provided) of location information into MBMS Service Area Identities subject to operator policies.
8a-8c. If xMB is used, the Create Session procedure (see clause 5.4.2 of 3GPP TS 26.348 v16.3.0), Get Session Properties (see clause 5.4.3 of 3GPP TS 26.348 v16.3.0) and the Update Session Procedure (see clause 5.4.4 of 3GPP TS 26.348 v16.3.0) is executed with the following changes and clarification:
   SCEF acts as a Content Provider.
   After completion of the Get Session Properties procedure, the Session Type value is set to “Files” by the SCEF irrespective of the received value for this parameter.
   In step 1 of Update Session procedure, the SCEF may include location information from step 6, session start and session stop. If no location information is provided in step 6 of this procedure, then the SCEF, based on local configuration, may use either a list of MBMS Service Area Identities, or a list of cell IDs, or both as the MBMS broadcast area. The SCEF may need to derive the session start based on the Message Delivery Start Time if provided in step 6 and the session stop based on the Message Delivery Stop Time if provided in step 6. Session Resource ID (as defined in 3GPP TS 26.348 v16.3.0) in Create Session response sent by the BM-SC to SCEF uniquely identifies an MBMS session during which MBMS service data is sent. Given that an MBMS session can target a certain MBMS Service Area via a TMGI and an MBMS Service Area description, it can be mapped to a specific group (i.e., MBMS UEs belonging to that group and which have received MBMS service announcement information containing the TMGI of the MBMS bearer service associated with this MBMS session can activate reception for that session).
   In step 2 of Update Session procedure, the BM-SC may map the civic address(es) (if provided) and/or geographic area(s) (if provided) of location information into MBMS Service Area Identities subject to operator policies.

In the case of xMB, depending on the service created, the BM-SC may send the service announcement information to the UE as specified in 3GPP TS 26.348 v16.3.0. The service announcement information may be referenced by the ServiceId which is provided by the BM-SC to the SCEF and then forwarded to the SCS/AS for service identification.
9. The BM-SC may initiate the MBMS Session Start procedure towards RAN via Core Network entities.
10. Void.
11. The SCEF may send a Group Message Response (TLTRI, TMGI (MB2 only), Acceptance Status, (optional) SCEF Message Delivery IP address/port) message to the SCS/AS to indicate whether the Request has been accepted for delivery to the group. The SCEF may send Acceptance Status of TMGI to indicate whether activation of MBMS bearer corresponding to the TMGI is accepted or rejected. If Group Message Payload is not included in step 6, then the SCEF may also send SCEF Message Delivery IP address and port number to the SCS/AS. It is noted that the SCEF can map BM-SC address and port number (received in step 8 for MB2 or xMB delivery) to a different IP address and port number to be used between the SCEF and the SCS/AS for delivery of group message payload.
12. Application level interactions may be applied for the devices of specific group to retrieve the related MBMS service information, e.g. TMGI, start time. Application level interactions between the UE and the SCS/AS are not discussed here. When using xMB, the application may receive the appropriate information through MBMS device access point identifiers (APIs) from the MBMS Client (see 3GPP TS 26.347 v16.3.1).
13a. If Group Message Payload is included in step 6, then at Message Delivery Start Time, the SCEF may deliver to the BM-SC the Group Message Payload(s) to corresponding to the MB2-U or the xMB-U IP address and port number associated with respective TMGI. If Group Message Payload is not included in step 6, then at or after the requested Group Message Start Time, but before the TMGI Expiration time (if MB2 is used) or Message Delivery Stop Time (if xMB is used), the SCS/AS may transfer the content to be delivered to the group to the SCEF using the SCEF Message Delivery IP address and port number received at step 11, and then the SCEF may deliver the content to the BM-SC. The BM-SC may transfer the corresponding content to UEs. The SCS/AS may repeat Step 13a unless the Message Delivery Stop Time is reached. To avoid that potential responses to the broadcast message by high numbers of devices are sent at almost the same time, it is recommended that the SCS/AS can provide the UEs with a response time window if it expects the UEs to respond to the delivered content.

Subsequent to this step, it is up to the SCS/AS if the MBMS bearers will be kept active and allocated and for how long. The mechanisms defined in 3GPP TS 23.468 v16.0.0 or TS 26.348 v16.3.0 can be used by the SCEF to release the MBMS resources.
13b. Upon execution of 13a, the SCEF may send a Group Message Delivery (TLTRI, TMGI, Delivery Trigger Status) message to the SCS/AS to indicate whether group message delivery is triggered successful. TLTRI refers to the transaction identified by TLTRI in step 6. For the TMGI, the SCEF may send Delivery Trigger Status to indicate whether delivery of Group Message Payload corresponding to the TMGI is successful or not.
14. When a UE receives the Group Message Payload, it may initiate immediate or later communication with the SCS/AS. It is recommended that the UE application can ensure distribution of any responses within the response time window.

It can be appreciated that unless the SCS/AS wants to extend the expiration time for an allocated TMGI, steps 1-5 shown in FIG. 3D can be skipped if a valid TMGI allocation already exists or if the MBMS bearer activation is performed without TMGI pre-allocation.

3GPP TS 26.346 v16.9.1 specifies the file download delivery method in MBMS. MBMS download delivery method may use the FLUTE protocol (RFC 3926) when delivering content over MBMS bearers. MBMS download delivery method may use open mobile alliance (OMA) PUSH when delivering content over other universal mobile telecommunication system/evolved packet system (UMTS/EPS) bearers. Usage of FLUTE protocol is described in clause 7.2 of 3GPP TS 26.346 v16.9.1. Usage of OMA PUSH is described in clause 7.4 of 3GPP TS 26.346 v16.9.1. The FLUTE session set-up with real time streaming protocol (RTSP) is defined in clause 7.5 of 3GPP TS 26.346 v16.9.1.

FLUTE is built on top of the asynchronous layered coding (ALC) protocol instantiation (RFC 3450). ALC combines the layered coding transport (LCT) building block, a congestion control (CC) building block and the forward error correction (FEC) building block to provide congestion controlled reliable asynchronous delivery of content to an unlimited number of concurrent receivers from a single sender. As mentioned in RFC 3450, congestion control may be not appropriate in the type of environment that MBMS download delivery is provided, and thus congestion control may not be used for MBMS download delivery.

FIG. 3E is a diagram illustrating an exemplary building block structure of FLUTE according to an embodiment of the present disclosure. FLUTE may be carried over user datagram protocol/Internet protocol (UDP/IP), and may be independent of the IP version and the underlying link layers used.

ALC may use the LCT building block to provide in-band session management functionality. The LCT building block has several specified and under-specified fields that are inherited and further specified by ALC. ALC may use the FEC building block to provide reliability. The FEC building block allows the choice of an appropriate FEC code to be used within ALC, including using the no-code FEC code that simply sends the original data using no FEC coding. ALC is under-specified and generally transports binary objects of finite or indeterminate length. FLUTE is a fully-specified protocol to transport files (any kind of discrete binary object), and uses special purpose objects—the file description table (FDT) instances—to provide a running index of files and their essential reception parameters in-band of a FLUTE session. It is noted that one way of supporting the delivery of a subset of the nominally requested content by the DASH client which indicates explicit willingness to accept such incomplete content, and based on a specific UE implementation architecture, is described in clause 7.2.3 in 3GPP TR 26.946.

3GPP TS 23.246 v16.1.0 describes MBMS Session Start towards E-UTRAN. The BM-SC may initiate an MBMS session start procedure when it is ready to send data. This may be a request to activate all necessary bearer resources in the network for the transfer of MBMS data and to notify interested UEs of the imminent start of the transmission. Through this procedure, MBMS session attributes such as QoS, MBMS service area, estimated session duration, may be provided to the registered gateway GPRS (General Packet Radio Service) serving node(s) (GGSN(s)) and serving GPRS support node(s) (SGSN(s)), to all base station controllers/radio network controllers (BSCs/RNCs) that are connected to a listed SGSN and to the registered MBMS gateway(s) (GW(s)) and mobility management entity(s) (MME(s)). In addition, the procedure allocates the bearer plane to all registered GGSNs, all registered SGSNs and all registered MBMS GWs, to BSCs/RNCs and E-UTRAN that respond to the session start request message. If IP multicast distribution of MBMS user plane data to E-UTRAN/UTRAN is supported, the MBMS-GW allocates an IP multicast address together with the corresponding IP address of the multicast source (i.e. MBMS GW) and the common-tunnel endpoint ID (C-TEID) are provided to the evolved node B (eNodeB) via MME and to the RNC via SGSN in this procedure. Optionally, in the case of E-UTRAN access (e.g. in deployments with a mix of IPV4 and IPV6 eNodeBs and/or backhauls) and if the MBMS GW supports both IPV4 and IPV6, both an IPV4 and an IPV6 IP multicast address together with the corresponding alternative IP addresses of the multicast source are also allocated by the MBMS GW and provided to the E-UTRAN via the MME. An IP multicast address and the paired IP address of the multicast source shall be of the same IP type.

After sending the Session Start Request message, the BM-SC may wait for a configurable delay (time to MBMS data transfer) before sending MBMS data. This delay may need to be long enough to avoid buffering of MBMS data in entities other than the BM-SC, i.e. the delay may need to allow the network to perform all procedures required to enable MBMS data transfer before the BM-SC sends MBMS data. For example, notification of UEs and radio bearer establishment may need to be performed before MBMS data arrive in the RAN. The delay may be in the region of multiple seconds or tens of seconds. It may be useful for the BM-SC to be able to configure different delays for MBMS bearer services on 2G, 3G and E-UTRAN, respectively.

For the distributed MCE architectures, i.e. when the multi-cell/multicast coordination entity (MCE) is part of the eNB as described in clause 15.1.1 in 3GPP TS 36.300 v16.7.0, an absolute time stamp for when data can be expected, “MBMS data transfer start”, may need to be used at multicast-broadcast single frequency network (MBSFN) operation mode to ensure synchronized session control and to facilitate a graceful reallocation of resources for the MBSFN when needed. When the parameter “MBMS data transfer start” is present, a receiving supporting node may need to ignore the parameter “time to MBMS data transfer”. For session stop signaling, the parameter “MBMS data transfer stop” is if present used to schedule the release of the radio resources in order to ensure a synchronized session control.

As described in clause 8.3.2 “MBMS Session Start Procedure for E-UTRAN and UTRAN for EPS” of 3GPP TS 23.246 v16.1.0, the list of downstream nodes of BM-SC and the list of MBMS control plane nodes (MMEs and SGSNs) of MBMS GW may be achieved in the following ways:
The list of MBMS control plane nodes for MBMS GW will be sent from the BM-SC to the MBMS GW in the Session Start Request.

Normally, the MBMS GW contained in the “list of downstream nodes” for BM-SC is the default MBMS GW (or two for resilience).

FIGS. 3F-3G are diagrams illustrating exemplary session start procedures according to some embodiments of the present disclosure. Specifically, FIG. 3F and FIG. 3G may correspond to “FIG. 8b.1: Session Start procedure for E-UTRAN and UTRAN for EPS” and “FIG. 8b.2: Session Start procedure for E-UTRAN for EPS with delayed response” in 3GPP TS 23.246 v16.1.0, respectively. As shown in FIGS. 3F-3G, the session start procedure may include the following steps:
1. The BM-SC may send a Session Start Request message to the MBMS GW to indicate the impending start of the transmission and to provide the session attributes (TMGI, Flow Identifier, QoS, MBMS service Area, list of cell IDs if available, Session identifier, estimated session duration, list of MBMS control plane nodes (MMEs, SGSNs) for MBMS GW, time to MBMS data transfer, MBMS data transfer start, access indicator, . . . ). The message may be sent to the MBMS GWs listed in the “downstream nodes” parameter of the corresponding MBMS Bearer Context in the BM-SC. The BM-SC may start multiple sessions for the same MBMS bearer service (identified by the TMGI) but with different content. If so, a flow identifier may be included in the Session Start Request to identify the different sub-sessions and the associated MBMS Service Areas may need not to overlap. The access indicator indicates in which radio access types the MBMS service may need to be broadcasted, i.e. UTRAN, or E-UTRAN, or both. The access indicator may be included in charging information generated by the MBSM GW. If the MBMS GW is configured to delay response to BMSC when access type is E-UTRAN, then the MBMS GW may delay response to the BM-SC (i.e. step 2) until after step 6 is executed as shown in FIG. 3G. This configuration may need to be only performed when E-UTRAN executes step 7 below before responding to the MBMS Session Start message as specified in 3GPP TS 36.300 v16.7.0. It is noted that it is up to the operator to ensure that E-UTRAN, MBMS GW and BMSC are configured only when E-UTRAN supports delaying the response from the eNB.
2. The MBMS GW may respond with a Session Start Response message with information for BM-SC to send MBMS data to the MBMS GW, if FIG. 3F is executed. The MBMS GW may respond only after first MME response in step 6 is received, if it is configured to do so as shown in FIG. 3G.
3. The MBMS GW may create an MBMS bearer context. The MBMS GW stores the session attributes and the list of MBMS control plane nodes in the MBMS bearer context and allocates a transport network IP multicast address or, optionally, for E-UTRAN access (e.g. in deployments with a mix of IPV4 and IPV6 eNodeBs and/or backhauls) and if the MBMS GW supports both IPv4 and IPV6, both an IPV4and an IPV6 IP multicast address, according to clause 6.5.3 of 3GPP TS 23.246 v16.1.0 and a C-TEID for this session. The MBMS GW may send a Session Start Request message including the session attributes (TMGI, Flow Identifier, QoS, MBMS service Area, list of cell IDs if available, Session identifier, estimated session duration, transport network IP Multicast Address(es), IP address(es) of the multicast source, C-TEID, . . . ) to MMEs and/or SGSNs listed in the “list of MBMS control plane nodes” parameter after filtering the list using the access indicator, thus ignoring entries not consistent with the access indicator.
4. The MME or SGSN may create an MBMS bearer context. The MME/SGSN stores the session attributes and sends a Session Start Request message including the session attributes (TMGI, QOS, MBMS service area, list of cell IDs if available, Session identifier, estimated session duration, broadcast (for UTRAN only), transport network IP Multicast Address, IP address of the multicast source, C-TEID, . . . ) to E-UTRAN/UTRAN. Optionally, in the case of E-UTRAN access and if the MBMS GW supports both IPv4 and IPV6, the MME may include both an IPV4 and an IPV6 IP Multicast address together with the corresponding alternative IP address(es) of the multicast source. When connected to multiple MCEs, the MME may need to filter the distribution of Session Control message to the MCEs based on the MBMS service area. For UTRAN, if one or more of the downstream nodes accepts the Session Start with the proposed IP Multicast and Source addresses for backbone distribution and the proposed C-TEID, the SGSN may include an indication that IP Multicast distribution is accepted in the MBMS Session Start Response message to the MBMS GW. If one or more of the downstream nodes does not accept the proposed IP Multicast and Source addresses for backbone distribution or the proposed C-TEID, the SGSN may fall back to normal point-to-point MBMS bearer establishment for these nodes and respond with an MBMS Session Start Response message providing the TEID for bearer plane that the MBMS GW may need to use for forwarding the MBMS data. Otherwise if all nodes accept multicast, the SGSN may return the C-TEID and the IP Multicast distribution address in the Session Start Response message. For E-UTRAN access, the eNB may respond to Session Start Request after first successful MBMS resources have been reserved (i.e. step 7) which indicates to the BMSC that there are resources already available for MBMS data delivery, as shown in FIG. 3G.
5. The E-UTRAN/UTRAN may create an MBMS bearer context. The E-UTRAN/UTRAN stores the session attributes, sets the state attribute of its MBMS Bearer Context to ‘Active’ (in UTRAN only) and responds the MME/SGSN to confirm the reception of the Session Start Request message. When a cell ID list is included in the Session Start Request, E-UTRAN may use it to determine a set of radio resources to be used for the broadcast. Based on the cell ID list, the set of radio resources selected may be reduced from the full set of resources defined by the MBMS service area. The E-UTRAN ensures that all of its corresponding nodes make the same decision on the reduced set. For UTRAN, if an RNC accepts the Session start and the proposed IP Multicast and Source addresses for backbone distribution and the proposed C-TEID, the RNC sends an MBMS Session Start Response message to SGSN including an indication that IP Multicast distribution is accepted. If an RNC does not accept the proposed IP Multicast and Source address for backbone distribution (or the proposed C-TEID), the RNC falls back to normal point-to-point MBMS bearer establishment.
6. The MME/SGSN may store the session attributes and the identifier of the eNBs/RNCs as the “list of downstream nodes” parameter in its MBMS Bearer Context and respond to the MBMS GW. The SGSN may need to wait for a response from all UTRAN nodes (until an acceptable duration) to be able to report to the MBMS GW whether all, part or none of the RNCs have accepted IP multicast distribution and to provide an SGSN IP address and TEID for user plane over Sn if some RNCs did not accept IP multicast distribution. The MME may return an MBMS Session Start Response to the MBMS-GW as soon as the session request is accepted by one E-UTRAN node. The MBMS GW initiates IP Multicast distribution and/or point-to-point MBMS bearers (for UTRAN only) depending on the responses from the MMEs/SGSNs. If the MBMS GW is configured to delay response to the BMSC, MBMS GW waits until step 6 occurs before responding to the BMSC as shown in FIG. 3G.
7. The E-UTRAN/UTRAN may establish the necessary radio resources for the transfer of MBMS data to the interested UEs. For E-UTRAN the radio resource set up may be scheduled using the MBMS data transfer start parameter if it is present, otherwise using the time to MBMS data transfer parameter. The MBMS data transfer start parameter is not used by UTRAN.
8. If the E-UTRAN/UTRAN node accepts IP Multicast distribution, it may join the appropriate transport network IP multicast address (including the IP address of the multicast source) allocated by the MBMS GW, to enable reception of MBMS data. If several MBMS bearer services use the same IP multicast address, the join may be only done once.
9. The BM-SC starts sending the MBMS data.
10. The MBMS GW function receives MBMS data. The MBMS GW may send the MBMS data using IP multicast distribution towards all joined eNodeBs/RNCs.

3GPP TS 26.348 v16.3.0 specifies user plane for file delivery over xMB reference point. According to the description of “File Distribution” in clause 5.5.2 of 3GPP TS 26.348 v16.3.0, provisioning files for file distribution may use one of the following options:
Web-based Distributed Authoring and Versioning (WebDAV) as described in RFC 4918 over Hyper Text Transfer Protocol (HTTP) over transport layer security (TLS). The content provider may provide an authorization access token with every Hyper Text Transfer Protocol over Secure Socket Layer (HTTPS) transaction.
HTTP over TLS for file retrieval. The BM-SC may need to use at least HTTP Version 1.1.

The content provider may need to ensure that content is available at the BM-SC prior to its scheduled transmission time. For instance, for DASH segments, the segment may need to be pushed to the BM-SC considering the timing requirements indicated in the media presentation description (MPD).

Also for all files that are declared as part of the file list of a session, all declared files may need to be available before their indicated availability time, or if not provided, prior to the session start.

As an alternative to providing the properties and transport-related requirements of a file-based service, for delivery over the MBMS bearer service, via the ‘File List’ property of the ‘Session’ resource in subclause 5.4.6 of 3GPP TS 26.348 v16.3.0, the content provider may elect to convey the same information via the File Delivery Manifest, as described in clause 5.6 of 3GPP TS 26.348 v16.3.0.

According to 3GPP TS 23.682 v17.2.0, when an SCS/AS sends a group message to an SCEF, the SCEF is expected to deliver the group message to a group of UEs using MBMS. However, the problem is that a BM-SC does not support a group message delivery method. What the BM-SC supports are: download delivery method, streaming delivery method, group communication delivery method, and transparent delivery method. It may be possible that the SCEF converts the group message into a file and requests the BM-SC to deliver the file over MBMS. But the UEs may not receive the file, since the file meta data is held by the SCEF. Without such information, the UEs may not be able to understand the file properly. It may result in that the group message cannot be delivered to the UEs via MBMS. Similarly, it may be problematical to deliver a group message using MBS. Therefore, it may be desirable to support group message delivery over MBMS/MBS.

Various exemplary embodiments of the present disclosure propose a solution for group message delivery, which can enable a group message to be delivered to and understood by one or more UEs. The proposed solution may cover three deployments:
Group message delivery using MBS in 5GS;
Group message delivery using MBMS in EPS (also called “eMBMS”); and
Group message delivery with interworking between MBS and eMBMS.

Corresponding to the above deployments, an AF may send a group message to an NEF, an SCEF, or SCEF+NEF, respectively.

In MBS deployment in 5GS, the system may perform the following operations:
Operation #1.1: An NEF may determine file meta data based on a group message provided by an AF. It may send the file meta data to the AF, so that the AF can perform the service announcement to pass the file information (e.g., the file meta data, etc.) to one or more UEs.
Operation #1.2: The NEF may invoke the interface provided by an MBSF, to request file delivery via one or more of the following two options:
   Option 1: The NEF may transform or encapsulate the group message into a file.
      Option 1.1: The NEF may push the file to an MBSTF via WebDAV ingestion.
      Option 1.2: The NEF may provide the download URL to the MBSF. The MBSF may send the URL to the MBSTF, and the MBSTF may pull the file from the NEF via HTTP(s). It may be possible that the NEF may upload the file to an HTTP server and the MBSTF may download the file from the HTTP server.
   Option 2: The NEF may send the group message to the MBSF in a message delivery request. The MBSF may send the group message to the MBSTF. The MBSTF may transform or encapsulate the group message into a file.
Operation #1.3: The MBSF may request an MB-SMF to start a broadcast MBS session, and the MBSTF may utilize the “file delivery” function to encode the file (include FEC encoding) and deliver the packetized file (e.g., via ROUTE or FLUTE) to an MB-UPF. And then, 5GC can deliver the packetized file towards the UEs over MBS broadcast via NG-RAN.
Operation #1.4: Based on the service announcement, the UEs can decode the received file from Uu and get the group message from the file.

In eMBMS deployment, the system may perform the following operations:
Operation #2.1: Same as Operation #1.1 above, except that an SCEF is used instead of an NEF.
Operation #2.2: Same as Operation #1.2 above, except that an SCEF is used instead of an NEF and a BM-SC is used instead of an MBSTF.
Operation #2.3: The BM-SC may start an MBMS session. The BM-SC may utilize the “file delivery” function to encode the file (include FEC encoding) and deliver the packetized file (e.g., via FLUTE) to an MBMS-GW to E-UTRAN. The E-UTRAN may broadcast the file over Uu.
Operation #2.4: Same as Operation #1.4 above.

In the deployment with interworking between MBS and eMBMS, compared to the MBS deployment in 5GS, the system may perform the following operations:
Operation #3.1: Same as Operation #1.1 above, except that NEF+SCEF is used instead of an NEF.
Operation #3.2: Same as Operation #1.2 above, except that NEF+SCEF is used instead of an NEF, and BM-SC+MBSF+MBSTF is used instead of an MBSTF.
Operation #3.3: In interworking deployment, BM-SC+MBSF+MBSTF may start an MBMS session towards EPS nodes and/or start an MBS broadcast session towards 5GC NFs. BM-SC+MBSF+MBSTF may utilize the “file delivery” function to encode the file (include FEC encoding). The packetized file may be delivered from BM-SC+MBSF+MBSTF to E-UTRAN via EPC and/or to NG-RAN via 5GC separately.
Operation #3.4: Same as Operation #1.4 above.

According to various embodiments of the present disclosure, the group message delivery via MBMS/MBS may be implemented by sending file meta data from NEF/SCEF to an AF, which enabling the AF to perform the service announcement to UE(s). The proposed group message delivery may be performed in different deployments, e.g., over MBMS, MBS and/or MBS with interworking with MBMS, adapting to various network configurations and service requirements.

FIG. 4A is a diagram illustrating exemplary group message delivery over MBMS in EPS according to an embodiment of the present disclosure. Compared to the procedure shown in FIG. 3D, some steps/operations for group message meta data are introduced into the group message delivery procedure of FIG. 4A, so that UE(s) can interpret a group message using the group message meta data obtained from an SCS/AS. If reference point MB2 is used, the procedure of group message delivery using MBMS as shown in FIG. 4A may include the following steps:
1. If there is no assigned TMGI for an External Group ID, the SCS/AS may send the Allocate TMGI Request (External Group ID, SCS Identifier, (optional) location information, Accuracy) message to the SCEF. The SCS/AS may determine the IP address(es)/port(s) of the SCEF by performing a DNS query using the External Group ID or using a locally configured SCEF identifier/address. The location information restricts the distribution of the group message. It takes the format indicated in Accuracy parameter which can be either a list of cell IDs, or a list of MBMS Service Areas, or civic addresses, or a geographic area or a combination of any of the above. Using the location information, the SCEF may check whether the SCS/AS is authorized to request TMGI allocation. If the expiration time for a previously allocated TMGI is to be extended, in addition to External Group ID, SCS Identifier and location/area information, the previously allocated TMGI may be included in the Allocate TMGI Request message. It is noted that a single SCEF can be connected to multiple BM-SCs in a given PLMN. The location information may be used to identify BM-SC(s) to which MB2-C/U messages are to be sent to.
2. The SCEF may determine whether the SCS/AS is authorized to request TMGI allocation.
3. The SCEF may initiate TMGI allocation by the BM-SC (e.g., see TMGI Allocation Procedure specified in 3GPP TS 23.468 v16.0.0). In this procedure, if the TMGI is not included in step 1, the SCEF may request allocation of only one TMGI. If a TMGI is included in step 1, the SCEF may request to extend the TMGI expiration time for that TMGI. The SCEF may store TMGI and TMGI expiration received in this step.
4. The SCEF may send Allocate TMGI Response (Cause, TMGI, TMGI expiration) message to the SCS/AS. Cause value indicates success or failure of the requested procedure. In the case of failure, the reason for the failure condition is also included. The TMGI allocated by the BM-SC to which the SCS/AS is expected to send the group message, and TMGI expiration indicating the expiration time for the TMGI are also included. It is noted that the SCEF may cache the serving BM-SC identity information and mapping between External Group ID and TMGI. Steps 5-14 may be skipped if the SCS/AS only wants to extend the expiration time of the TMGI (MB2 only).
5. Application level interactions may be applied for the devices of specific group to retrieve the related MBMS service information, e.g. TMGI, start time, etc. in the case of MB2. Application level interactions between the UE and the SCS/AS may be implemented in various suitable manners. It is noted that if reference point xMB is used, steps 1-5 may be skipped.
6. The SCS/AS may send the Group Message Request (External Group Identifier, SCS Identifier, TMGI (MB2 only), Message Delivery Stop Time (xMB only), optional (Group Message Payload, location information, Accuracy, Message Delivery Start Time) message to the SCEF. In the case of xMB, the SCEF may create a service using xMB for the group message and associate the external Group Identifier with the HTTP REST resource identifier of the service provided by the BM-SC upon service creation. The then SCEF may forward either only the ServiceID (see Table 5.4-1 in 3GPP TS 26.348 v16.3.0) to the SCS/AS or all service announcement. After the service is created, the SCS/AS may trigger session creation towards the SCEF. The SCEF may assign a TLTRI that identifies this group message delivery request. The location information may be included to identify the location over which group message is to be sent. It takes the format indicated in Accuracy parameter which can be either a list of cell IDs, or a list of MBMS Service Areas, or civic addresses, or a geographic area, or a combination of any of the above. The Message Delivery Start Time indicates the time at which the group message is to be sent by the network on the MBMS bearer(s). If not included, the group message is expected to be sent immediately. The Message Delivery Stop Time indicates the time at which the group message delivery is expected to be completed. When included, Group Message Payload indicates the payload the SCS/AS intends to deliver to UEs. Absence of Group Message Payload is indicative of the SCS/AS using delivery of group message in step 13a. It is noted that a single Group Message Payload can be sent to all included TMGIs (MB2 only). Whether actual payload or a reference to the payload (e.g. URI) is sent in this step is left to Stage 3. In the case of the latter, the SCEF may download the payload prior to step 13. In the case of xMB, if the application in the UE receives a ServiceId through application level interaction, the application can activate reception using MBMS device APIs (see 3GPP TS 26.347 v16.3.1).
7. The SCEF may check that the SCS/AS is authorized to send a group message request. It may also check to see if Message Delivery Start Time does not start after the TMGI expiration (MB2 only). In the case of xMB, the SCEF ensures that the xMB session stop time is not before the Message Delivery Start Time. If either of the checks fails, then the SCEF executes step 11 with a cause value indicating the reason for the failure condition and the flow stops at this step. In this case, the SCS/AS may subsequently release the TMGI allocated at step 3 by requesting an explicit de-allocation, or may rely on the expiration timer. In an embodiment, if Group Message Payload is included in step 6, then step 7a and optionally step 7b may be performed.
7a. The SCEF may determine the group message meta data (e.g. fileURI and/or fileURL, etc.).
7b. (Option-1) The SCEF may transform the received group message into a file. In an embodiment, the group message may not be identified by a file URI/URL and not available on an HTTP server for download. So, the SCEF may transform the message (temporarily) into a file, e.g., by storing it on a HTTP server.
8. If MB2 is used, the Activate MBMS Bearer Procedure (see clause 5.1.2.3.2 of 3GPP TS 23.468 v16.0.0) may be executed with the following changes:
   In step 1 of this procedure, the SCEF, acting as GCS AS, may include location information from step 6. If no location information is provided in step 6 of this procedure, then the SCEF, based on local configuration, may use either a list of MBMS Service Area Identities, or a list of cell IDs, or both as the MBMS broadcast area.
   In step 2 of this procedure, the BM-SC may map the civic address(es) (if provided) and/or geographic area(s) (if provided) of location information into MBMS Service Area Identities subject to operator policies.
8a-8c. If xMB is used, the Create Session procedure (see clause 5.4.2 of 3GPP TS 26.348 v16.3.0), Get Session Properties (see clause 5.4.3 of 3GPP TS 26.348 v16.3.0) and the Update Session Procedure (see clause 5.4.4 of 3GPP TS 26.348 v16.3.0) is executed with the following changes and clarification:
   SCEF acts as a Content Provider.
   After completion of the Get Session Properties procedure, the Session Type value is set to “Files” by the SCEF irrespective of the received value for this parameter.
In step 1 of Update Session procedure, the SCEF may include location information from step 6, session start and session stop. If no location information is provided in step 6 of this procedure, then the SCEF, based on local configuration, may use either a list of MBMS Service Area Identities, or a list of cell IDs, or both as the MBMS broadcast area. The SCEF may need to derive the session start based on the Message Delivery Start Time if provided in step 6 and the session stop based on the Message Delivery Stop Time if provided in step 6. Session Resource ID (as defined in 3GPP TS 26.348 v16.3.0) in Create Session response sent by the BM-SC to SCEF uniquely identifies an MBMS session during which MBMS service data is sent. Given that an MBMS session can target a certain MBMS Service Area via a TMGI and an MBMS Service Area description, it can be mapped to a specific group (i.e., MBMS UEs belonging to that group and which have received MBMS service announcement information containing the TMGI of the MBMS bearer service associated with this MBMS session can activate reception for that session).
   In step 2 of Update Session procedure, the BM-SC may map the civic address(es) (if provided) and/or geographic area(s) (if provided) of location information into MBMS Service Area Identities subject to operator policies. In accordance with an embodiment, the SCEF may also provide the file meta data information (e.g., group message meta data, etc.) to the BM-SC in this step.

In the case of xMB, depending on the service created, the BM-SC may send the service announcement information to the UE as specified in 3GPP TS 26.348 v16.3.0. The service announcement information may be referenced by the ServiceId which is provided by the BM-SC to the SCEF and then forwarded to the SCS/AS for service identification.
9. The BM-SC may initiate the MBMS Session Start procedure towards RAN via Core Network entities.
10. Void.
11. The SCEF may send a Group Message Response (TLTRI, TMGI (MB2 only), Acceptance Status, (optional) SCEF Message Delivery IP address/port, [file meta data]) message to the SCS/AS to indicate whether the Request has been accepted for delivery to the group. The SCEF may send Acceptance Status of TMGI to indicate whether activation of MBMS bearer corresponding to the TMGI is accepted or rejected. If Group Message Payload is not included in step 6, then the SCEF may also send SCEF Message Delivery IP address and port number to the SCS/AS. Otherwise, the SCEF may send the file meta data (e.g. fileURI and/or fileURL, etc.) to the SCS/AS. It is noted that the SCEF can map BM-SC address and port number (received in step 8 for MB2 or xMB delivery) to a different IP address and port number to be used between the SCEF and the SCS/AS for delivery of group message payload.
12. Application level interactions may be applied for the devices of specific group to retrieve the related MBMS service information, e.g. TMGI, start time. If file delivery applies, the file meta data may need to be sent to the UE. Application level interactions between the UE and the SCS/AS may be implemented in various ways. When using xMB, the application may receive the appropriate information through MBMS device APIs from the MBMS Client (see 3GPP TS 26.347 v16.3.1).
If Group Message Payload is included in step 6, then step 12a in Option-1 and/or steps 12b-12d in Option-2 may be performed; Otherwise step 13a may be performed.
12a. (Option-1) The SCEF may push the file to the BM-SC via WebDAV, or the BM-SC may pull the file from the SCEF via HTTP(s). It may also be possible that the SCEF can upload the file to an HTTP server and the BM-SC may pull the file from the HTTP server. The BM-SC may perform file partition, FEC encoding, etc. At Message Delivery Start Time, the BM-SC may deliver the packet(s) from the FEC encoded file using FLUTE (e.g., as specified in 3GPP TS 26.346 v16.9.1).
12b. (Option-2) The SCEF may send a Group Message Delivery Request to the BM-SC for xMB with the group message payload.
12c. (Option-2) The BM-SC may transform the group message into a file. The BM-SC may perform file partition, FEC encoding, etc. At Message Delivery Start Time, the BM-SC may deliver the packet(s) from the FEC encoded file using FLUTE (e.g., as specified in 3GPP TS 26.346 v16.9.1).
12d. (Option-2) The BM-SC may respond OK to the SCEF.
13a. At or after the requested Group Message Start Time, but before the TMGI Expiration time (if MB2 is used) or Message Delivery Stop Time (if xMB is used), the SCS/AS may transfer the content to be delivered to the group to the SCEF using the SCEF Message Delivery IP address and port number received at step 11, and then the SCEF may deliver the content to the BM-SC. The BM-SC may transfer the corresponding content to UEs. The SCS/AS may repeat Step 13a unless the Message Delivery Stop Time is reached. To avoid that potential responses to the broadcast message by high numbers of devices are sent at almost the same time, it is recommended that the SCS/AS can provide the UEs with a response time window if it expects the UEs to respond to the delivered content.

Subsequent to step 12a, or step 12c, or step 13a, it is up to the SCS/AS if the MBMS bearers will be kept active and allocated and for how long. The mechanisms defined in 3GPP TS 23.468 v16.0.0 or TS 26.348 v16.3.0 can be used by the SCEF to release the MBMS resources.
13b. Upon execution of step 13a, the SCEF may send a Group Message Delivery (TLTRI, TMGI, Delivery Trigger Status) message to the SCS/AS to indicate whether group message delivery is triggered successful. TLTRI refers to the transaction identified by TLTRI in step 6. For the TMGI, the SCEF may send Delivery Trigger Status to indicate whether delivery of Group Message Payload corresponding to the TMGI is successful or not.
14. When a UE receives the Group Message Payload, it may initiate immediate or later communication with the SCS/AS. It is recommended that the UE application can ensure distribution of any responses within the response time window.

FIG. 4B is a diagram illustrating exemplary group message delivery over MBS broadcast in 5GS according to an embodiment of the present disclosure. Some network elements such as a UE, a RAN (e.g., NG-RAN), an MB-SMF/MB-UPF/AMF, an MBSF, an MBSTF, an NEF and an AF may be involved in the exemplary procedure illustrated in FIG. 4B. It can be appreciated that network elements and signaling messages shown in FIG. 4B are just as examples, and more or less alternative network elements and signaling messages may be involved in the group message delivery over MBS broadcast according to various embodiments of the present disclosure. In accordance with an exemplary embodiment, the group message delivery over MBS broadcast as shown in FIG. 4B may include the following steps:
1. The AF may send a Group Message Request message to the NEF, containing a group message (e.g., the group message payload), together with the start time, stop time, etc.
2. The NEF may check that the AF is authorized to send a group message request.
3. The NEF may determine group message meta data information (also called file meta data), e.g., including but not limited to fileURI and/or fileURL, etc.
4. Option-1: The NEF may transform the group message into a file.
5-7. The NEF may perform Create Session, Get Session Properties, and Update Session Procedure towards the MBSF. In an embodiment, when updating the session, the file meta data (e.g., fileURI and/or fileURL, etc.) may be updated towards the MBSF.
8. The NEF may send a Group Message Response towards the AF, including the file meta data (e.g., fileURI and/or fileURL, etc.).
9. Based on the information received from the NEF, the AF may perform Service Announcement towards the UE, with the file meta data. It may be optional if the file meta data has been announced to the UE (e.g., if the same fileURI/fileURL is used for group message delivery).
10. The MBSF may also create session and update session towards the MBSTF. The file meta data may also be sent to the MBSTF.
11. Option-1: The NEF may push the file to the MBSTF via WebDAV, or the MBSTF may pull the file from the NEF via HTTP(s). It may also be possible that the NEF uploads the file to an HTTP server and the MBSTF pulls the file from the HTTP server.
12. Option-2: The NEF may send the group message delivery request with the group message meta data information and the group message to the MBSF. The MBSF may respond the NEF.
13. Option-2: The MBSF may send a group message delivery request with the group message meta data information and the group message to the MBSTF. The MBSTF may send a respond to the MBSF.
14. Option-2: The MBSTF may transform the group message into a file.
15. The MBSTF may perform file partition, FEC encoding, etc.
16. The MBSF may request the MB-SMF to create an MBS broadcast session, and the MBS broadcast session may start, e.g., as specified in 3GPP TS 23.247 v17.1.0.
17. The MBSTF may deliver the file towards the MB-UPF over FLUTE or ROUTE. The MB-UPF may deliver the file towards the NG-RAN, and the NG-RAN may perform MBS broadcast.
18. The UE may receive the packets (of the file) over Uu. Based on the received file meta data from the AF, the UE can decode the file and get the group message payload from the file.

FIG. 4C is a diagram illustrating exemplary group message delivery over MBMS and MBS broadcast according to an embodiment of the present disclosure. Some network elements such as a UE, a NG-RAN, an E-UTRAN, an MB-SMF/MB-UPF/AMF, an MBMS-GW/MME, BM-SC+MBSF/MBSTF, NEF+SCEF and an AF may be involved in the exemplary procedure illustrated in FIG. 4C. It can be appreciated that network elements and signaling messages shown in FIG. 4C are just as examples, and more or less alternative network elements and signaling messages may be involved in the group message delivery over MBMS and MBS broadcast according to various embodiments of the present disclosure. In accordance with an exemplary embodiment, the group message delivery over MBMS and MBS broadcast as shown in FIG. 4C may include the following steps:
1. The AF may send a Group Message Request message to the NEF+SCEF, containing a group message (e.g., the group message payload), together with the start time, stop time, etc.
2. The NEF+SCEF may check that the AF is authorized to send a group message request.
3. The NEF+SCEF may determine group message meta data information or file meta data.
4. Option-1: The NEF+SCEF may transform the received group message into a file.
5-7. The NEF+SCEF may perform Create Session, Get Session Properties, and Update Session Procedure towards the BM-SC+MBSF+MBSTF. In an embodiment, when updating the session, the file meta data (e.g., fileURI and/or fileURL, etc.) may be updated towards the BM-SC+MBSF+MBSTF.
8. The NEF+SCEF may send a Group Message Response towards the AF, including the file meta data (e.g., fileURI and/or fileURL, etc.)
9. Based on the information received from the NEF+SCEF, the AF may perform Service Announcement towards the UE, with the file meta data. It may be optional if the file meta data has been announced to the UE (e.g., if the same fileURI/fileURL is used for group message delivery).
10. Option-1: The NEF+SCEF may push the file to the BM-SC+MBSF+MBSTF via WebDAV, or the BM-SC+MBSF+MBSTF may pull the file from the NEF+SCEF via HTTP(s). It may also be possible that the NEF+SCEF uploads the file to an HTTP server and the BM-SC+MBSF+MBSTF pulls the file from the HTTP server.
11. Option-2: The NEF+SCEF may send a group message delivery request with the group message meta data information and the group message to the BM-SC+MBSF+MBSTF. The BM-SC+MBSF+MBSTF may send a response to the NEF+SCEF.
12. Option-2: The BM-SC+MBSF+MBSTF may transform the group message into a file.
13. The BM-SC+MBSF+MBSTF may perform file partition and FEC encoding, etc.
14. The BM-SC+MBSF+MBSTF may request the MB-SMF to create and start an MBS broadcast session towards 5GC. Alternatively or additionally, it may also start an MBMS broadcast session towards EPC.
15. The BM-SC+MBSF+MBSTF may deliver the file towards the MBMS-GW over FLUTE or ROUTE. The MBMS-GW may deliver the file towards the E-UTRAN, and the E-UTRAN may perform MBMS broadcast.
16. Alternative or additional to step 15, the BM-SC+MBSF+MBSTF may deliver the file towards the MB-UPF over FLUTE or ROUTE. The MB-UPF may deliver the file towards the NG-RAN, and the NG-RAN may perform MBS broadcast.
17. The UE may receive the packets (of the file) from the E-UTRAN and/or the NG-RAN. Based on the received file meta data from the AF, the UE may be able to decode the file and get the group message payload from the file.

It can be appreciated that although some exemplary embodiments are described in the context of MBMS/MBS broadcast, various embodiments described in the present disclosure may also be applicable to other communication scenarios such as MBMS/MBS multicast, so that a group message can be provided to one or more UEs in an efficient and flexible way.

FIG. 5A is a flowchart illustrating a method 510 according to some embodiments of the present disclosure. The method 510 illustrated in FIG. 5A may be performed by a UE or an apparatus communicatively coupled to the UE. In accordance with an exemplary embodiment, the UE may be, for example, a subscriber station, a portable subscriber station, a mobile station (MS) or an access terminal (AT). The UE may include, but not limited to, portable computers, image capture terminal devices such as digital cameras, gaming terminal devices, music storage and playback appliances, a mobile phone, a cellular phone, a smart phone, a tablet, a wearable device, a personal digital assistant (PDA), a vehicle, and the like.

According to the exemplary method 510 illustrated in FIG. 5A, the UE may obtain meta data information of a group message from an application server (e.g., a SCS/AS/AF, etc.), as shown in block 512. In accordance with an exemplary embodiment, the UE may receive a file from a multicast/broadcast service entity (e.g., a BM-SC and/or an MBSF entity and/or an MBSTF entity, etc.), as shown in block 514. The file may be transformed from the group message. According to the meta data information, the UE may transform the file into the group message, as shown in block 516.

In accordance with an exemplary embodiment, the UE may obtain the meta data information via service announcement by the application server. In an embodiment, the meta data information may include a URL of the file.

In accordance with an exemplary embodiment, the UE may receive the file from the multicast/broadcast service entity via a file delivery over MBMS and/or MBS.

FIG. 5B is a flowchart illustrating a method 520 according to some embodiments of the present disclosure. The method 520 illustrated in FIG. 5B may be performed by a multicast/broadcast service entity or an apparatus communicatively coupled to the multicast/broadcast service entity. In accordance with an exemplary embodiment, the multicast/broadcast service entity may be a BM-SC and/or an MBSF entity and/or an MBSTF entity. According to the exemplary method 520 illustrated in FIG. 5B, the multicast/broadcast service entity may obtain a file which is transformed from a group message, as shown in block 522. In accordance with an exemplary embodiment, the multicast/broadcast service entity may transmit the file to one or more UEs via a file delivery over MBMS and/or MBS, as shown in block 524.

In accordance with an exemplary embodiment, the multicast/broadcast service entity may receive meta data information of the group message from a capability exposure entity (e.g., a SCEF entity and/or an NEF entity, etc.).

In accordance with an exemplary embodiment, the meta data information may be received by the multicast/broadcast service entity in an update session procedure and/or a message delivery request from the capability exposure entity. In an embodiment, the meta data information may include a URL of the file.

In accordance with an exemplary embodiment, the multicast/broadcast service entity may obtain the file via pushing the file from a capability exposure entity to the multicast/broadcast service entity. Alternatively or additionally, the multicast/broadcast service entity may obtain the file via pulling the file from the capability exposure entity to the multicast/broadcast service entity directly or via a data server (e.g., a HTTP server, etc.).

In accordance with an exemplary embodiment, the multicast/broadcast service entity may obtain the file by receiving a message delivery request from a capability exposure entity (e.g., a SCEF entity and/or an NEF entity, etc.). The message delivery request may include the group message. In accordance with an exemplary embodiment, the multicast/broadcast service entity may obtain the file further by transforming the group message into the file.

In accordance with an exemplary embodiment, prior to transmitting the file to the one or more UEs, the multicast/broadcast service entity may perform file partition and encoding for the file and start a MBMS and/or MBS session for the group message.

FIG. 5C is a flowchart illustrating a method 530 according to some embodiments of the present disclosure. The method 530 illustrated in FIG. 5C may be performed by a capability exposure entity or an apparatus communicatively coupled to the capability exposure entity. In accordance with an exemplary embodiment, the capability exposure entity may be an NEF entity and/or an SCEF entity. According to the exemplary method 530 illustrated in FIG. 5C, the capability exposure entity may determine meta data information of a group message received from an application server (e.g., an SCS/AS/AF, etc.), as shown in block 532. In accordance with an exemplary embodiment, the capability exposure entity may transmit the meta data information to the application server, as shown in block 534. In accordance with an exemplary embodiment, the capability exposure entity may provide the group message in a first format or a second format to a multicast/broadcast service entity (e.g., a BM-SC and/or an MBSF entity and/or an MBSTF entity, etc.), as shown in block 536. In an embodiment, the first format may be different from the second format.

In accordance with an exemplary embodiment, the capability exposure entity may transmit the meta data information to the multicast/broadcast service entity. In an embodiment, the meta data information may be transmitted to the multicast/broadcast service entity in an update session procedure and/or a message delivery request from the capability exposure entity. According to an exemplary embodiment, the meta data information may include a URL of a file transformed from the group message.

In accordance with an exemplary embodiment, the group message in the first format may be a file transformed from the group message. In an embodiment, the capability exposure entity may provide the group message in the first format to the multicast/broadcast service entity via pushing the file from the capability exposure entity to the multicast/broadcast service entity. Alternatively or additionally, the capability exposure entity may provide the group message in the first format to the multicast/broadcast service entity via pulling the file from the capability exposure entity to the multicast/broadcast service entity directly or via a data server (e.g., a HTTP server, etc.).

In accordance with an exemplary embodiment, the group message in the second format may be the group message included in a message delivery request.

FIG. 5D is a flowchart illustrating a method 540 according to some embodiments of the present disclosure. The method 540 illustrated in FIG. 5D may be performed by an application server (e.g., an AF, an SCS, an AS, etc.) or an apparatus communicatively coupled to the application server. According to the exemplary method 540 illustrated in FIG. 5D, the application server may transmit a group message of one or more UEs to a capability exposure entity (e.g., an SCEF entity and/or a NEF entity, etc.), as shown in block 542. In accordance with an exemplary embodiment, the application server may receive meta data information of the group message from the capability exposure entity, as shown in block 544. In accordance with an exemplary embodiment, the application server may provide the meta data information to the one or more UEs, as shown in block 546.

In accordance with an exemplary embodiment, the application server may provide the meta data information to the one or more UEs via service announcement. In accordance with another exemplary embodiment, the meta data information may include a URL of a file transformed from the group message.

The various blocks shown in Figs.5A-5D may be viewed as method steps, and/or as operations that result from operation of computer program code, and/or as a plurality of coupled logic circuit elements constructed to carry out the associated function(s). The schematic flow chart diagrams described above are generally set forth as logical flow chart diagrams. As such, the depicted order and labeled steps are indicative of specific embodiments of the presented methods. Other steps and methods may be conceived that are equivalent in function, logic, or effect to one or more steps, or portions thereof, of the illustrated methods. Additionally, the order in which a particular method occurs may or may not strictly adhere to the order of the corresponding steps shown.

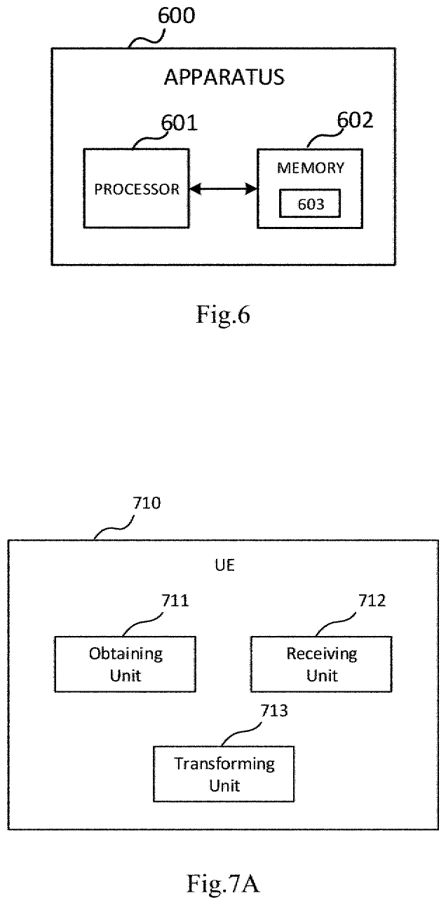

FIG. 6 is a block diagram illustrating an apparatus 600 according to various embodiments of the present disclosure. As shown in FIG. 6, the apparatus 600 may comprise one or more processors such as processor 601 and one or more memories such as memory 602 storing computer program codes 603. The memory 602 may be non-transitory machine/processor/computer readable storage medium. In accordance with some exemplary embodiments, the apparatus 600 may be implemented as an integrated circuit chip or module that can be plugged or installed into a UE as described with respect to FIG. 5A, or a multicast/broadcast service entity as described with respect to FIG. 5B, or a capability exposure entity as described with respect to FIG. 5C, or an application server as described with respect to FIG. 5D. In such cases, the apparatus 600 may be implemented as a UE as described with respect to FIG. 5A, or a multicast/broadcast service entity as described with respect to FIG. 5B, or a capability exposure entity as described with respect to FIG. 5C, or an application server as described with respect to FIG. 5D.

In some implementations, the one or more memories 602 and the computer program codes 603 may be configured to, with the one or more processors 601, cause the apparatus 600 at least to perform any operation of the method as described in connection with FIG. 5A. In other implementations, the one or more memories 602 and the computer program codes 603 may be configured to, with the one or more processors 601, cause the apparatus 600 at least to perform any operation of the method as described in connection with FIG. 5B. In other implementations, the one or more memories 602 and the computer program codes 603 may be configured to, with the one or more processors 601, cause the apparatus 600 at least to perform any operation of the method as described in connection with FIG. 5C. In other implementations, the one or more memories 602 and the computer program codes 603 may be configured to, with the one or more processors 601, cause the apparatus 600 at least to perform any operation of the method as described in connection with FIG. 5D. Alternatively or additionally, the one or more memories 602 and the computer program codes 603 may be configured to, with the one or more processors 601, cause the apparatus 600 at least to perform more or less operations to implement the proposed methods according to the exemplary embodiments of the present disclosure.

FIG. 7A is a block diagram illustrating an apparatus 710 according to some embodiments of the present disclosure. As shown in FIG. 7A, the apparatus 710 may comprise an obtaining unit 711, a receiving unit 712 and a transforming unit 713. In an exemplary embodiment, the apparatus 710 may be implemented in a UE. The obtaining unit 711 may be operable to carry out the operation in block 512, the receiving unit 712 may be operable to carry out the operation in block 514, and the transforming unit 713 may be operable to carry out the operation in block 516. Optionally, the obtaining unit 711, the receiving unit 712 and/or the transforming unit 713 may be operable to carry out more or less operations to implement the proposed methods according to the exemplary embodiments of the present disclosure.

FIG. 7B is a block diagram illustrating an apparatus 720 according to some embodiments of the present disclosure. As shown in FIG. 7B, the apparatus 720 may comprise an obtaining unit 721 and a transmitting unit 722. In an exemplary embodiment, the apparatus 720 may be implemented in a multicast/broadcast service entity (e.g., a BM-SC/MBSF/MBSTF, etc.). The obtaining unit 721 may be operable to carry out the operation in block 522, and the transmitting unit 722 may be operable to carry out the operation in block 524. Optionally, the obtaining unit 721 and/or the transmitting unit 722 may be operable to carry out more or less operations to implement the proposed methods according to the exemplary embodiments of the present disclosure. In an embodiment, the apparatus 720 may optionally comprise a transforming unit (not shown in FIG. 7B) for transforming a group message into a file.

FIG. 7C is a block diagram illustrating an apparatus 730 according to some embodiments of the present disclosure. As shown in FIG. 7C, the apparatus 730 may comprise a determining unit 731, a transmitting unit 732 and a providing unit 733. In an exemplary embodiment, the apparatus 730 may be implemented in a capability exposure entity (e.g., an NEF/SCEF, etc.). The determining unit 731 may be operable to carry out the operation in block 532, the transmitting unit 732 may be operable to carry out the operation in block 534, and the providing unit 733 may be operable to carry out the operation in block 536. Optionally, the determining unit 731, the transmitting unit 732 and/or the providing unit 733 may be operable to carry out more or less operations to implement the proposed methods according to the exemplary embodiments of the present disclosure. In an embodiment, the apparatus 730 may optionally comprise a receiving unit (not shown in FIG. 7C) for receiving a group message from an application server (e.g., an SCS/AS/AF, etc.). In another embodiment, the apparatus 730 may optionally comprise a transforming unit (not shown in FIG. 7C) for transforming the group message into a file.

FIG. 7D is a block diagram illustrating an apparatus 740 according to some embodiments of the present disclosure. As shown in FIG. 7D, the apparatus 740 may comprise a transmitting unit 741, a receiving unit 742 and a providing unit 743. In an exemplary embodiment, the apparatus 740 may be implemented in an application server (e.g., an SCS/AS/AF, etc.). The transmitting unit 741 may be operable to carry out the operation in block 542, the receiving unit 742 may be operable to carry out the operation in block 544, and the providing unit 743 may be operable to carry out the operation in block 546. Optionally, the transmitting unit 741, the receiving unit 742 and/or the providing unit 743 may be operable to carry out more or less operations to implement the proposed methods according to the exemplary embodiments of the present disclosure.

In general, the various exemplary embodiments may be implemented in hardware or special purpose chips, circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, random access memory (RAM), etc. As will be appreciated by one of skill in the art, the function of the program modules may be combined or distributed as desired in various embodiments. In addition, the function may be embodied in whole or partly in firmware or hardware equivalents such as integrated circuits, field programmable gate arrays (FPGA), and the like.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

1-39. (canceled)

40. A method performed by a user equipment, UE, comprising:
obtaining from an application sever a service announcement comprising meta data information of a file to get a group message;
receiving the file from a multicast/broadcast service entity; and
getting the group message from the file according to the service announcement.

41. The method according to claim 40, wherein the file is encoded by the multicast/broadcast service entity.

42. The method according to claim 41, wherein before the step of getting the group message from the file, the method further comprising:
performing decoding to restore the file.

43. The method according to claim 40, wherein the meta data information includes a uniform resource locator, URL, of the file.

44. The method according to claim 40, wherein the UE receives the file from the multicast/broadcast service entity via a file delivery over multimedia broadcast/multicast service, MBMS, and/or multicast/broadcast service, MBS.

45. The method according to claim 40, wherein the multicast/broadcast service entity is: a broadcast/multicast-service center, BM-SC; and/or a multicast/broadcast service function, MBSF, entity; and/or a multicast/broadcast service transport function, MBSTF, entity.

46. A user equipment, UE, comprising:
one or more processors; and
one or more memories comprising computer program codes,
the one or more memories and the computer program codes configured to, with the one or more processors, cause the UE at least to:
obtain from an application server a service announcement comprising meta data information of a file to get a group message;
receive the file from a multicast/broadcast service entity; and
get the group message according to the service announcement.

47. A method performed by a capability exposure entity, comprising:
determining meta data information of a group message received from an application server;
transmitting the meta data information to the application server; and
providing the group message in a first format to a multicast/broadcast service entity.

48. The method according to claim 47, further comprising:
transmitting the meta data information to the multicast/broadcast service entity.

49. The method according to claim 48, wherein the meta data information is transmitted to the multicast/broadcast service entity in an update session procedure from the capability exposure entity.

50. The method according to claim 47, wherein the meta data information includes a uniform resource locator, URL, of a file transformed from the group message.

51. The method according to claim 47, wherein the group message in the first format is a file transformed from the group message.

52. The method according to claim 51, wherein the capability exposure entity provides the group message in the first format to the multicast/broadcast service entity via one or more of:
pushing the file from the capability exposure entity to the multicast/broadcast service entity; and
pulling the file from the capability exposure entity to the multicast/broadcast service entity directly or via a data server.

53. The method according to claim 47, wherein the capability exposure entity is: a network exposure function, NEF, entity; and/or a service capability exposure function, SCEF, entity.

54. The method according to claim 47, wherein the multicast/broadcast service entity is: a broadcast/multicast-service center, BM-SC; and/or a multicast/broadcast service function, MBSF, entity; and/or a multicast/broadcast service transport function, MBSTF, entity.
